(19) United States
(12) Patent Application Publication
(10) Pub. No.: US 2024/0123356 A1
(43) Pub. Date: Apr. 18, 2024

(54) GENERATING SOCIAL CONNECTIONS WITH SOCIAL NETWORKS

(71) Applicant: Pickleplay, LLC, Cedar Falls, IA (US)

(72) Inventor: Blake Renaud, Cedar Falls, IA (US)

(21) Appl. No.: 18/487,752

(22) Filed: Oct. 16, 2023

Related U.S. Application Data
(60) Provisional application No. 63/379,644, filed on Oct. 14, 2022.

(51) Int. Cl. A63F 13/795; A63F 13/87

(52) U.S. Cl. CPC A63F 13/795; A63F 13/87; A63F 2300/556; A63F 2300/5566; A63F 2300/572

(57) ABSTRACT

The need for increased human interaction beyond traditional social activities is increasing especially in the post-Covid-19 era. Social networks can assist individuals in creating connections and interacting with other people. However, it is often difficult for individuals with specific interests in emerging competitive activities to find other people with similar interests on traditional social networks. As discussed in more detail below, the present disclosure relates to creating a social network for individuals sharing common interests in a variety of competitive activities. The benefit of this approach is that it creates a dedicated social network where a like-minded community can be formed to connect players from around the world to participate in friendly competition.

### CROSS-REFERENCE TO RELATED APPLICATIONS

This application claims priority to U.S. Provisional Patent Application No. 63/379,644, filed Oct. 14, 2022, which is incorporated herein by reference in its entirety.

### BACKGROUND

Social networks have created an opportunity for individuals with specific interests in a variety of activities to connect and share with other people. However, the increased connectivity has also created a problem where an individual may be interested in a topic but there are not enough other users on their social network interested in the same activity to generate consistent communication and participation in the event. This issue is particularly acute when the user's specific interest in in an emerging competitive activity where interest among the general public growing but still relatively new, as in the case of pickleball.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to connecting users of a social network with each other for communication about and participation in competitive activities, like pickleball. In some embodiments, a social network is created as a mobile application or web-based application where users may join the social network to communicate about shared interests in competitive activities and participate in the competitive activities. In some embodiments, users may create events, post looking for play requests, clubs, make posts on a feed, connect with other users, rate courts, and earn rewards for their participation. This provides the benefit of connecting users with specific interests in competitive activities on a dedicated social network.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a diagram illustrating a system for connecting users of a social network, according to aspects described herein.

FIG. 2 is a block diagram illustrating a method for processing a play request, according to aspects described herein.

FIG. 3A is an example of one version of the welcome page for the application.

FIG. 3B is an example of another version of the welcome page for a new user.

FIG. 3C is an example of one version of the login screen for the application.

FIG. 3D is an example of a login screen using the in-application email and password option.

FIG. 3E is an example of a reset password screen for the application.

FIG. 3F is an example of the new password screen which the user would see after clicking on the password reset option from the email sent in connection with FIG. 3E.

FIG. 4A is an example of a create an account screen where new users may create an account in the application.

FIG. 4B is an example of a second account creation screen where the user may input the name they prefer to use on the application and upload a profile photo.

FIG. 4C is an example of what the user would see if they selected the option to upload a profile photo in FIG. 4B.

FIG. 4D is an example of what the user would see once they have uploaded a photo and input their name in FIGS. 4B-4C.

FIGS. 4E, 4F, 4G, 4H, 4I, 4J, and 4K are examples of additional account creation screen where the user may enter additional information to their profile.

FIG. 4L is an example of an account creation screen where the user may select their skill level at a particular competitive activity.

FIG. 4M is an example of an in-application purchase screen that may be offered during account creation and/or accessible on demand within the application.

FIG. 5A is an example of a map in the application.

FIG. 5B is an example of a court search screen in the application.

FIG. 5C is an example of a user selecting a court icon on the map.

FIG. 5D is an example of a full information screen on the application for a court or other area for participating in the competitive activity.

FIG. 5E is an example of an option to add a court or share a competitive activity location with other users from the map screen.

FIG. 5F is an example of the add a court screen the user would see if they selected the tab in FIG. 5E.

FIG. 6A is an example of the events screen in the application.

FIG. 6B is an example of a review screen for a court with a star rating system and an option to enter text into the field.

FIG. 6C is an example of the check in screen for a user.

FIG. 6D is an example of a screen of checked in players at a location.

FIG. 6E is an example of a screen with user ratings for a location.

FIGS. 7A and 7B are examples of the feed that a user of the application may see on the home screen.

FIG. 7C is an example of a messages screen with no messages that a new user may see.

FIG. 7D is an example of a notifications screen with no notifications that a new user may see.

FIGS. 7E, 7F, and 7G are examples of posting screens where a user may write a post for display on the application feed.

FIG. 7H is an example of a notifications screen where the user may see notifications of activity from their feed, other users they follow, comments on their posts, and/or recommendations for the user based on their profile settings.

FIG. 8A is an example of a user's profile page on the application.

FIG. 8B is another user search screen where a user can look up other users by name and/or location.

FIG. 8C is an example of a player screen selected from FIG. 8B.

FIG. 8D is an example of a screen showing gamification of the application where the user has earned a reward and leveled up their user ranking.

FIGS. 9A and 9B are examples of event screens where a user may see events that they are participating in and/or search other events.

FIGS. 9C and 9D are example screens with event filters which may also be used to search events.

FIGS. 9E and 9F are an example of an event screen for a created event.

FIGS. 9G and 9H are an example of an add event page on the application.

FIGS. 10A, 10B, 10C, and 10D are examples of club pages for a user.

FIGS. 11A, 11B, 11C, 11D, and 11E are examples of looking for play screens that a user may utilize to enter and respond to a looking for play request.

FIG. 12 is a block diagram illustrating a method for processing generating and displaying map functionality.

FIG. 13 is a block diagram illustrating a method for processing generating and displaying map functionality.

FIG. 14 is a block diagram illustrating a method for generating an event list.

FIG. 15 is a block diagram illustrating a method for gamifying actions performed on a platform.

FIG. 16 is a block diagram illustrating a method for performing event operations on a centralized event platform.

FIG. 17 is a block diagram illustrating a method for generating an event list.

FIG. 18 is a block diagram illustrating a method for the centralized and verifiable management of league or tournament using a data platform.

FIG. 19A is an exemplary user interface for creating a league or tournament.

FIG. 19B is an exemplary user interface for searching for leagues or tournaments.

FIG. 20 illustrates a simplified block diagram of a device with which aspects of the present disclosure may be practiced in accordance with aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The need for increased human interaction beyond traditional social activities is increasing especially in the post-Covid-19 era. Social networks can assist individuals in creating connections and interacting with other people. However, it is often difficult for individuals with specific interests in emerging competitive activities to find other people with similar interests on traditional social networks. As discussed in more detail below, the present disclosure relates to creating a social network for individuals sharing common interests in a variety of competitive activities (e.g., pickleball, flag football, frisbee golf, board games, and other competitive activities). The benefit of this approach is that it creates a dedicated social network where a like-minded community can be formed to connect players from around the world to participate in friendly competition.

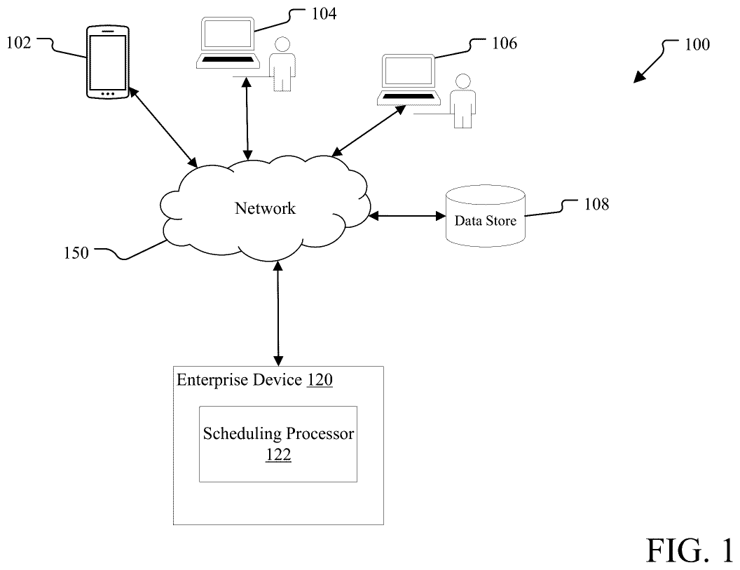

FIG. 1 is a diagram illustrating a system for connecting users of a social network, according to aspects described herein. A system 100 may include a mobile device 102, a first user device 104, a second user device 106, a data store 108, and an enterprise device 120 which communicate over a network 150. The enterprise device may include a scheduling processor 122. The network 150 may comprise one or more networks such as local area networks (LANs), wide area networks (WANs), enterprise networks, the Internet, etc. and may include one or more of wired, wireless, and/or optical portions.

In aspects, the mobile device 102, computer device 104, and computer device 106 may be any device that can receive, process, modify, and communicate content on the network 150. Examples of a mobile device 102, computer device 104, and computer device 106 include a smartphone, a mobile computer or mobile computing device (e.g., a Microsoft® Surface® device, a laptop computer, a notebook computer, a tablet computer such as an Apple iPad™, a netbook, etc.), or a stationary computing device such as a desktop computer or PC (personal computer), telephone, mobile device, and/or a wireless device where a customer, contact center agent, and/or contact center supervisor may interact with each other. Mobile device 102, computer device 104, and computer device 106 may be configured to execute one or more software applications (or “applications”) and/or services and/or manage hardware resources (e.g., processors, memory, etc.), which may be utilized by users of the mobile device 102, computer device 104, and computer device 106.

The mobile device 102, computer device 104, and computer device 106 may include an application (not pictured) which displays content for use on the mobile device 102, computer device 104, and computer device 106 and for communication across the network 150. The application may be a native application or a web-based application. The application may operate substantially locally to the mobile device 102, computer device 104, and computer device 106 or may operate according to a server/client paradigm in conjunction with one or more servers (not shown). The application may be used for communication across the network 150 or to view content relating to the repeatability metric. To facilitate ease of use across multiple device types, the web-based application and mobile application may be synced so that a user of either a mobile device 102 and/or a computer device 104 will see the same display pages (as described below) in the application. For ease of discussion, the description herein refers to a single mobile device 102, and a single computer device 104. But features and examples of the mobile device 102, and computer device 104, are applicable to multiple devices. Further, it is contemplated that the computer device 104 and computer device 106 are interchangeable within the context of the application as both devices are part of the larger network.

In accordance with some embodiments, the mobile device 102, the computer device 104, and enterprise device 120 may have access to data contained in a data store 108. The data store 108 may contain information related to users of the social network including user profile data, club information, event information, etc. Data store 108 is a network server, cloud server, network attached storage (“NAS”) device, or another suitable computing device. Data store 108 may include one or more of any type of storage mechanism, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data store 108 is shown in FIG. 1, the system 100 may include two, three, or more similar instances of the data store 108. Moreover, the network 150 may provide access to other data stores, similar to data store 108 that are located outside of the system 100, in some embodiments.

Enterprise device 120 may include one or more server devices, distributed computing platforms, cloud platform devices, processors, and/or other computing devices such as the scheduling processor 122. Enterprise device 120 and scheduling processor 122 communicate with data store 108, mobile device 102, computer device 104, and computer device 106 via network 150.

In a typical use scenario, a user may access the social network and be interested in finding a partner to play a competitive activity with (e.g., pickleball, golf, poker, a board game, basketball, flag football, frisbee golf, etc.). The user may select a tab on the user interface on a mobile application on mobile device 102 and/or a web-based application on user device 104. The selection may open a new page where the user may start a new play request. On the new play request page, the user may input one or more play parameters to define the type of activity the user is looking for. The play parameters may be a plurality of information related to the type of competitive activity that the user desires including type of competitive activity (e.g., pickleball, golf, poker, a board game, basketball, flag football, frisbee golf, etc.), location, desired and/or required skill level for the participants, date range, time, additional information field where any characters may be input, images, videos, links to other pages and/or events, selection of specific people to participate, and other parameters which are pertinent to the competitive activity. Once the user has input the play parameters, an indication to submit the play parameters may be received via the submit tab to submit the play request.

The play request may be sent to the scheduling processor 122 via the network 150 for processing and distribution throughout the network to other users. The scheduling processor 122 may post the play request on a public feed on the social network as an open invitation for users of the social network to connect with the play request and coordinate a competitive activity (e.g., pickleball, flag football, frisbee golf, board games, and other competitive activities). In some embodiments, the scheduling processor 122 may additionally receive the play request and process it to identify the relevant play parameters which were input by the user. The scheduling processor 122 may then identify other players who are potential players for the user's play request. These users may be selected based on a similarity to the user's play request such as similar location or range from the desired location (e.g., within 20 miles from the input location), similar skill level, interested in similar competitive activities, similar available date range, etc. Once potential players have been identified, the scheduling processor 122 may notify the identified potential players via a direct message or other notification to the user with the play request and a note explaining the play request. For example, an identified potential player may receive a direct message in the application on the user device 102 with an explanation of the play request and an option to select a link to message the requesting user and set up the competitive activity. Optionally, in some embodiments the scheduling processor 122 may track communications which occur between the identified potential players and the requesting user. This process enables the system to identify users who are more likely to participate in a competitive activity and highlight them to other users.

In other embodiments, the scheduling processor 122 may manage the map, map actions, user profile information, league profiles, club profiles, private groups, event information, user authentication, user onboarding, the network feed, and gamification of the social network. In some embodiments the scheduling processor 122 may manage users to check in at a location to show they are available to participate in a competitive activity. Checking in is an option where a player may notify other users of the application that they are actively at the court. In some embodiments the user may be able to set the period of time where they will be present at the court. In other embodiments a set time will be automatically given for each user who checks in to the court. The players who are checked in may be seen on the information screen as a short list with a selectable option to view all checked in players.

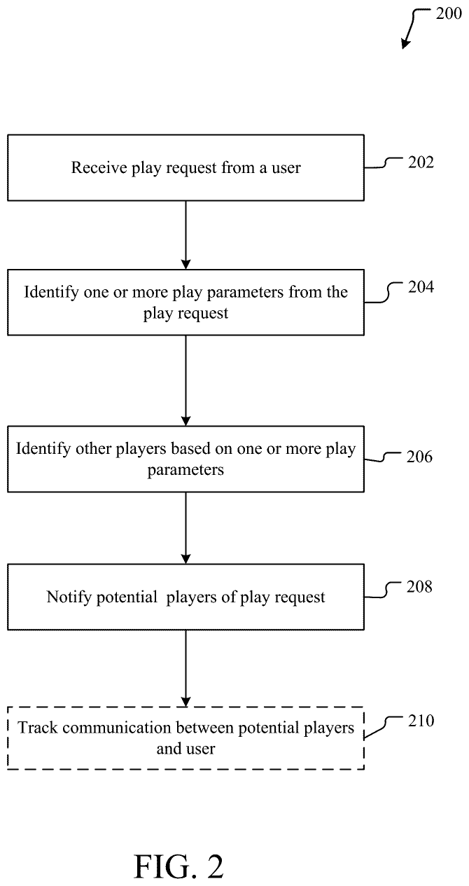

FIG. 2 is a block diagram illustrating a method for processing a play request, according to aspects described herein. A general order of the operations for the method 200 is shown in FIG. 2. Generally, the method 200 begins with operation 202 and ends with operation 210. The method 200 may include more or fewer steps or may arrange the order of the steps differently than those shown in FIG. 2. The method 200 can be executed as computer-executable instructions executed by a computer system and encoded or stored on a computer readable medium. Further, the method 200 can be performed by gates or circuits associated with a processor, an ASIC, an FPGA, a SOC or other hardware device. Hereinafter, the method 200 shall be explained with reference to the systems, components, devices, modules, software, data structures, data characteristic representations, signaling diagrams, methods, etc., described in conjunction with the other figures.

The method 200 begins with receive operation 202, where a scheduling processor (e.g., scheduling processor 122) receives a play request from a device associated with a user. The play request may be received by the system utilizing via application on a mobile device (e.g., mobile device 102) and/or a user device (e.g., user device 104). For example, an application on a mobile device may generate a play request and associated metadata (e.g., location data, player data, time data, etc.) and transmit the play request to the scheduling processor. The scheduling processor may receive the play request via a network, such as the Internet, via an API, or via another form of electronic communication or interface.

Flow progresses to identify operation 204, where a scheduling processor (e.g., scheduling processor 122) identifies one or more play parameters that are included in the play request and/or in the metadata associated with the play request. In examples, the play request may be parsed to identify the relevant play parameters. The request may include one or more play parameters which relate to the competitive activity which an associated user would like to find a competitor for.

Flow progresses to identify operation 206, where other players are identified as potential players for the play request. The scheduling processor (e.g., scheduling processor 122) may utilize the identified play parameters from the play request to identify other users who share similarity with the identified play parameters and may be a match for the user's play request. For example, a datastore of user profiles may be maintained by the scheduling processor. The database stores relevant parameters for each player. Relevant parameters may include, but are not limited to, location, availability, skill level, teammates, etc. The datastore is indexable and can be searched by relevant parameter. As such, at operation 206, a lookup can be performed using one or more parameters from the play request to identify one of more potential players. For example, the one or more potential players may be identified based on proximity to the location in the play request (e.g., within 20 miles of the location), skill level, similar interest in identified competitive activity, etc.

Flow progresses to notify operation 208, where a scheduling processor (e.g., scheduling processor 122) notify potential players of the play request. The scheduling processor may send a notification directly to the potential player in the application (e.g., a push notification), as an email, and/or through a message (e.g., a SMS message) on a mobile device (e.g., mobile device 102) and/or user device (e.g., user device 104).

Flow progresses to optional track operation 210, where a scheduling processor (e.g., scheduling processor 122) tracks any communication between the potential players and the user who submitted the play request. In examples, the scheduling processor may operate as a central communication hub, such that communications between different mobile devices are routed through the scheduling processor. This allows the scheduling processor to track data and store data from the communications between devices. Additionally, by using the scheduling processor as a communication hub, sensitive personal information, such as an individual's phone number, address, email address, etc., can be safely maintained by the scheduling processor. The system may track the communication to identify users who are more likely to participate in play requests and other activities on the social network. The tracking may occur by continually monitoring communications data between devices on the network (e.g., network 150).

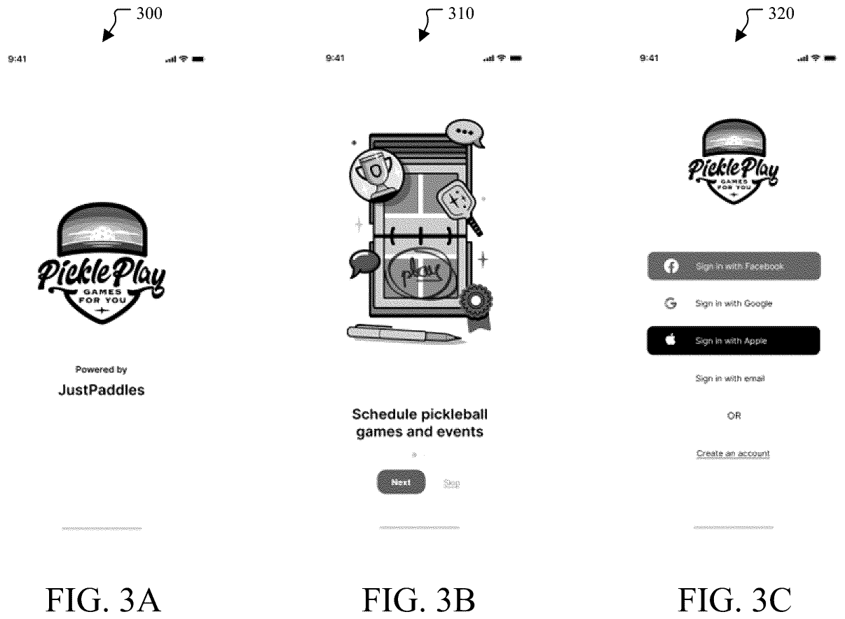

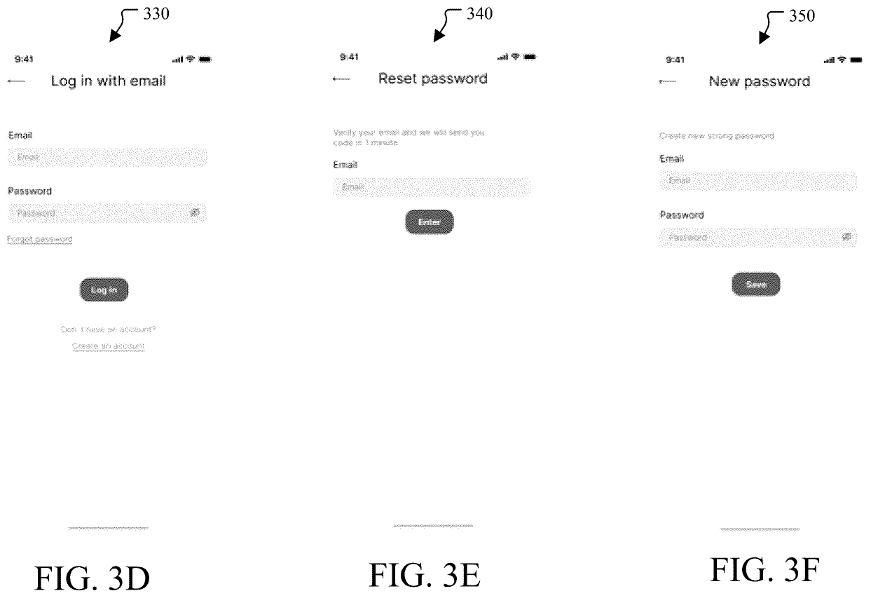

FIG. 3A is an example of one version of the welcome page for the application. The welcome page may include the website logo and additional text. FIG. 3B is an example of another version of the welcome page for a new user. This embodiment of the welcome page may include images and text as well as selectable options for viewing each of the welcome pages or skipping directly to the login screen. FIG. 3C is an example of one version of the login screen for the application. The login screen may include the application logo, selectable tabs to login with other username and password combinations for different applications, an option to sign in with email, and/or the option to create an account.

FIG. 3D is an example of a login screen using the in-application email and password option. There may be fields available to enter in the user's email and password, a forgot password selectable link, a selectable login tab, and a selectable link to create an account. FIG. 3E is an example of a reset password screen for the application. The user may be offered a field to enter their email and select a tab to receive an email with a password reset option. FIG. 3F is an example of the new password screen which the user would see after clicking on the password reset option from the email sent in connection with FIG. 3E. The user may receive a prompt with instructions, fields to enter their email and new password, and a selectable tab to save their changes.

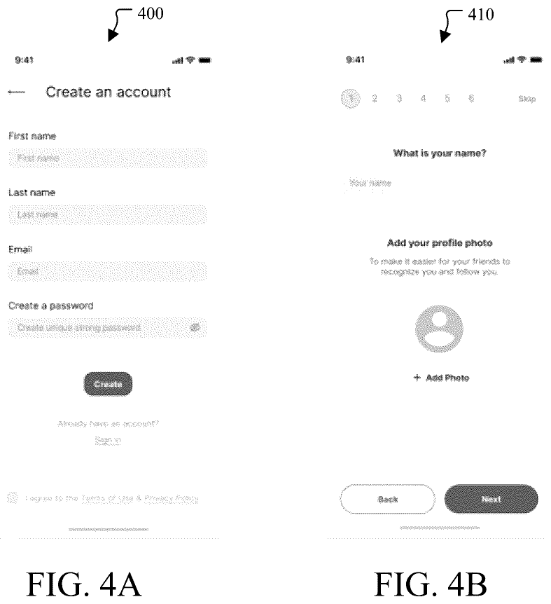

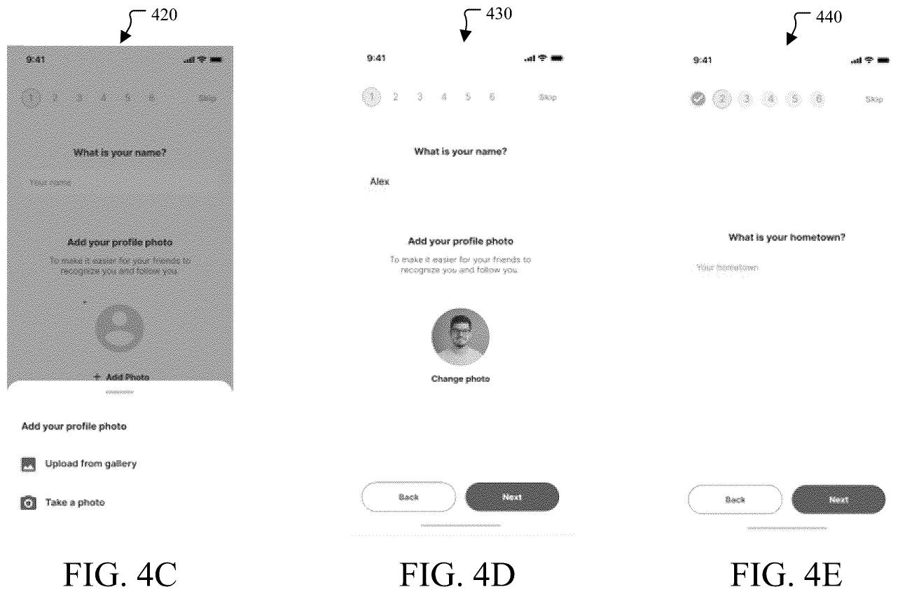

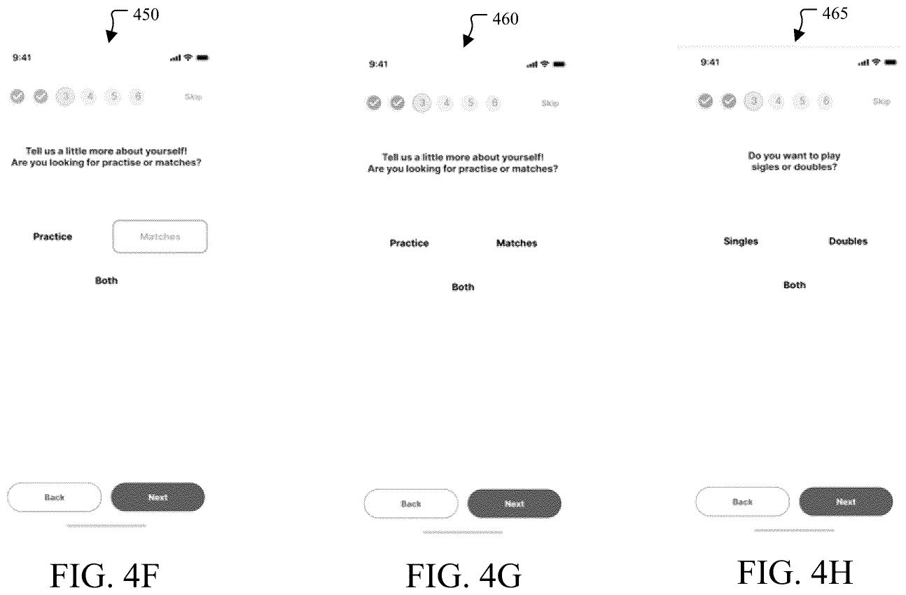

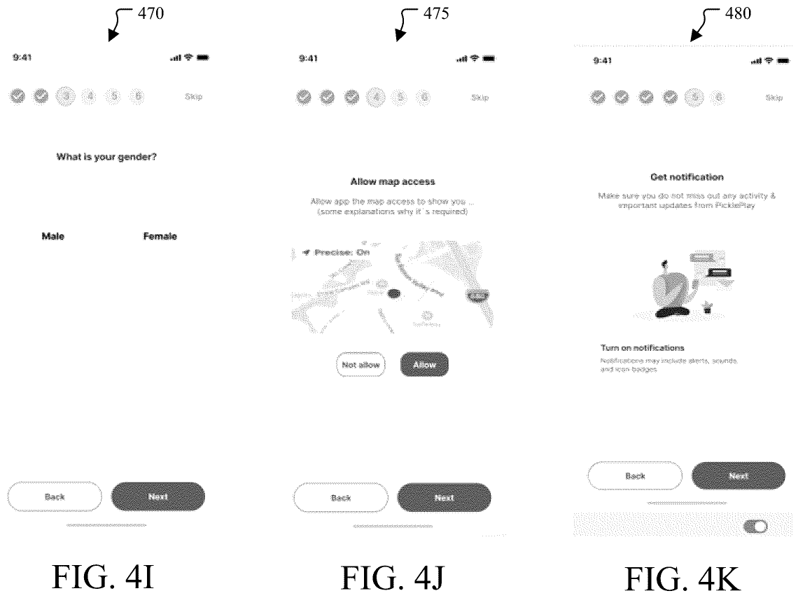

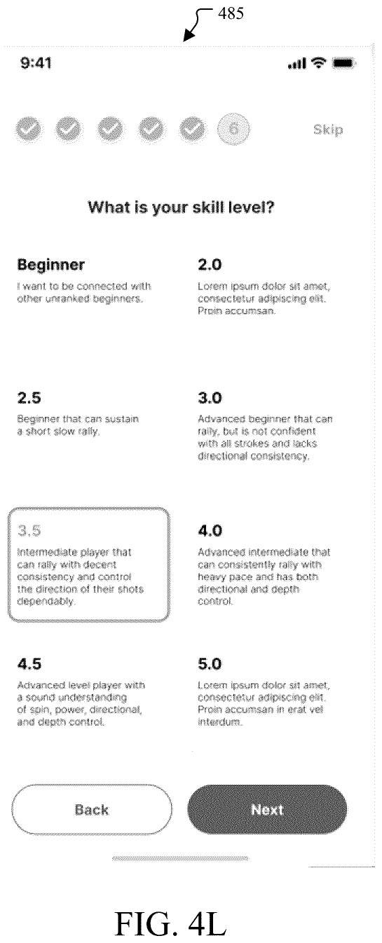

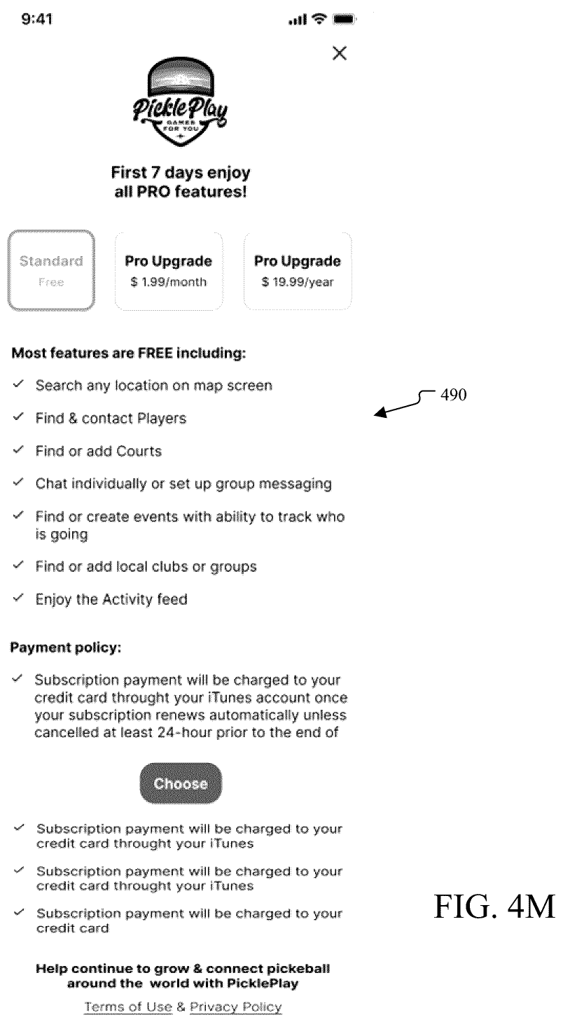

FIG. 4A is an example of a create an account screen where new users may create an account in the application. The screen may include fields for the user to enter their personal information, email address, and a password for the account. Additionally, there may be a selectable tab enabling the user to create the account, and/or an option to navigate to the login screen if they already have an account.

FIG. 4B is an example of a second account creation screen where the user may input the name they prefer to use on the application and upload a profile photo. The screen may include a selectable option to upload a photo, and selectable tabs to move back or forward between account creation screens. Also, page fields may be presented at the top of the screen alerting the user which page they are on, which steps of account creation they have completed, and optionally offering an option to skip the offered step in account creation.

FIG. 4C is an example of what the user would see if they selected the option to upload a profile photo in FIG. 4B. The user may be presented the option to upload the photo from a picture gallery or to take a photo. Also, page fields may be presented at the top of the screen alerting the user which page they are on, which steps of account creation they have completed, and optionally offering an option to skip the offered step in account creation.

FIG. 4D is an example of what the user would see once they have uploaded a photo and input their name in FIGS. 4B and 4C. Also, page fields may be presented at the top of the screen alerting the user which page they are on, which steps of account creation they have completed, and optionally offering an option to skip the offered step in account creation.

FIGS. 4E, 4F, 4G, 4H, 4I, 4J, and 4K are examples of additional account creation screen where the user may enter additional information to their profile. In various embodiments the user account information may include their hometown or location, if the user is interested in practice, matches, and/or both, the type of competitive activity that the user prefers as well as optional methods of playing that competitive activity, the user's gender, and/or options to select privacy preferences (e.g., notification settings, allowing map access, etc.). The user may enter this information via direct text entry and/or by selecting a tab on the screen. Selectable tabs may be presented for navigation between pages. Also, page fields may be presented at the top of the screen alerting the user which page they are on, which steps of account creation they have completed, and optionally offering an option to skip the offered step in account creation. The message displayed to users may transition based on the screen the user is on or in response to information being entered into the system. Example messages may include “Are you interested in Open Play or Tournaments or Both?”; “Tell us a little more about yourself! Are you looking for practice or matches?”; “Do you want to play singles or doubles?”; “What is your gender?”; and/or a plurality of other messages.

FIG. 4L is an example of an account creation screen where the user may select their skill level at a particular competitive activity. The skill level options may be offered as tabs for the user to select, as a direct entry field for text (not shown), and/or as a sliding scale with a sliding indicator which the user positions on their skill level. Selectable tabs may be presented for navigation between pages. Also, page fields may be presented at the top of the screen alerting the user which page they are on, which steps of account creation they have completed, and optionally offering an option to skip the offered step in account creation.

FIG. 4M is an example of an in-application purchase screen that may be offered during account creation and/or accessible on demand within the application. The screen may include the application logo, selectable options for the in-application purchase the user wants, images, and/or textual descriptions related to the purchase.

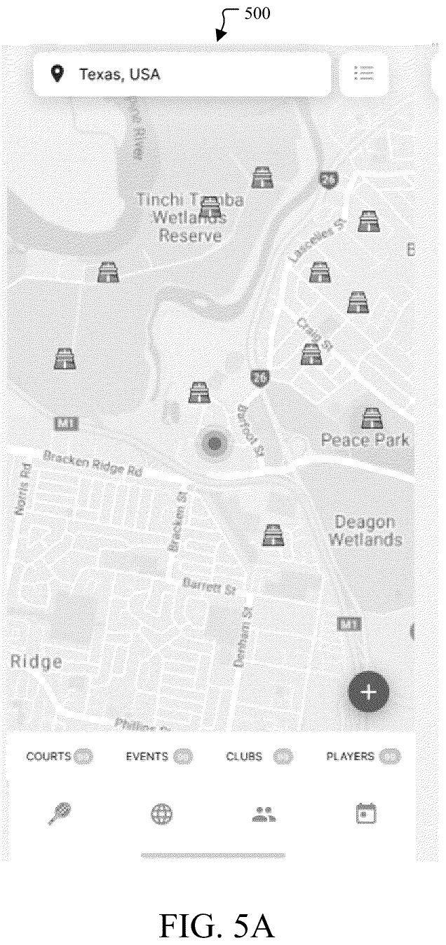

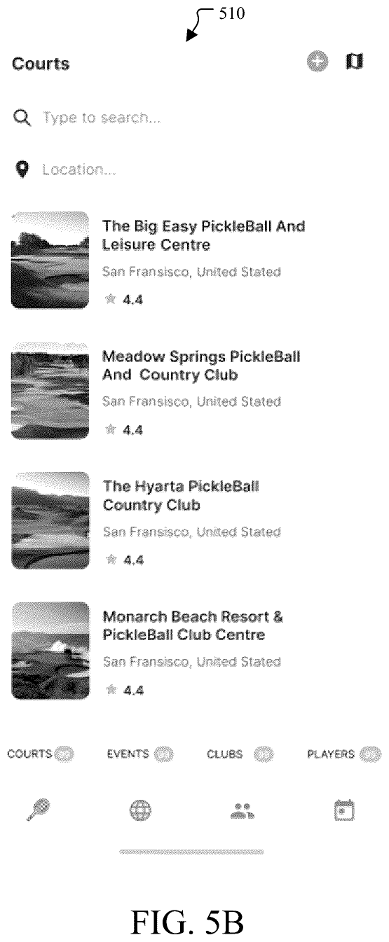

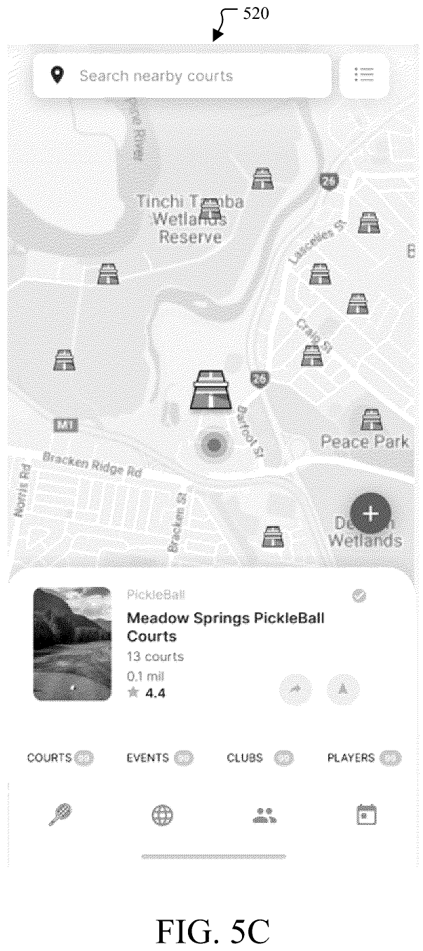

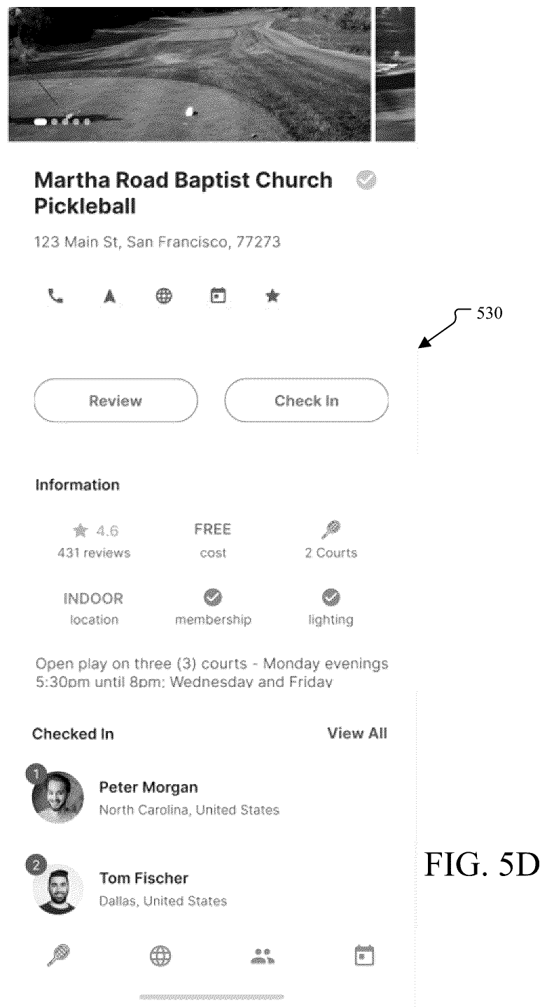

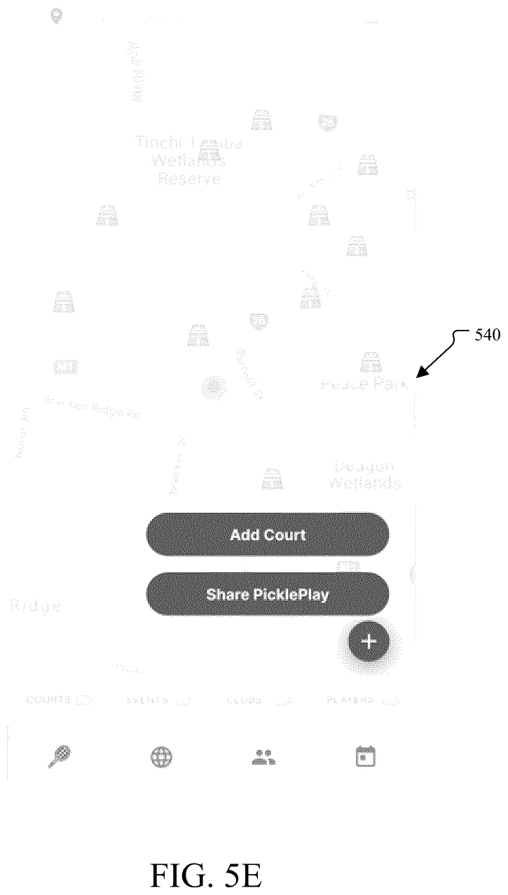

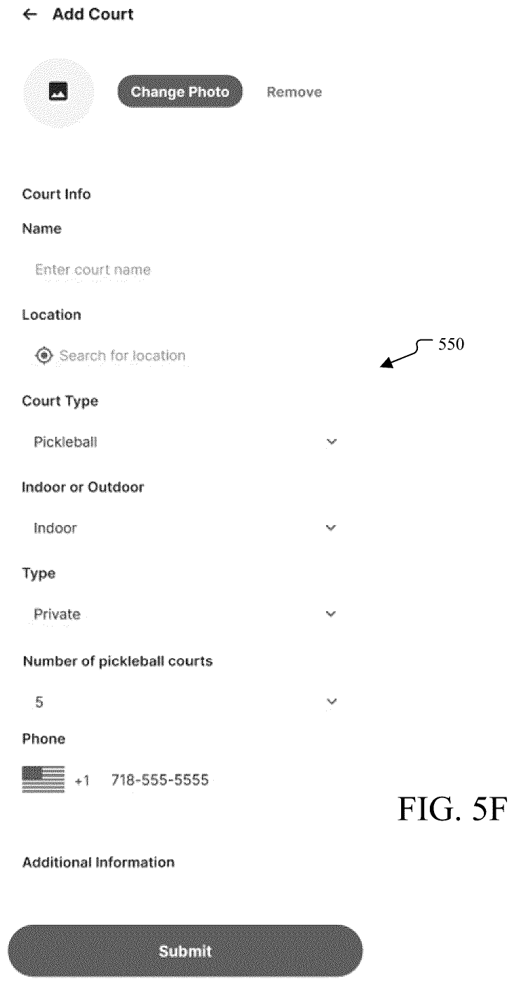

FIG. 5A is an example of a map in the application. The map may include an option to select a location, a visual depiction of the location including available courts and other options to participate in the competitive activity. There may be selectable options on screen as text and/or images to select different filters for the map including courts, events, clubs, and players within the location. The user's location may also be displayed on the map as a pointer.

FIG. 5B is an example of a court search screen in the application. The court search may be accessed by selecting the courts selectable option on the screen, as in FIG. 5A. The screen may include images, text, and selectable options displayed in a list of nearby courts and/or other areas to participate in the competitive activity. There may also be a search field and an area to enter a location to search.

FIG. 5C is an example of a user selecting a court icon on the map. Selecting the icon opens an information tab associated with the court at the bottom of the screen. The information tab may contain information, text, images, ratings, navigation options, scheduling options and other information associated with the court.

FIG. 5D is an example of a full information screen on the application for a court or other area for participating in the competitive activity. The screen may include the name of the location, images, options to call the location, directions, location on a map, calendar options, star options to make it a favorite, selectable tabs for reviewing or checking in, and other players checking in. Checking in is an option where a player may notify other users of the application that they are actively at the court. In some embodiments the user may be able to set the period of time where they will be present at the court. In other embodiments a set time will be automatically given for each user who checks in to the court. The players who are checked in may be seen on the information screen as a short list with a selectable option to view all checked in players.

FIG. 5E is an example of an option to add a court or share a competitive activity location with other users from the map screen. The user is presented with selectable options for each action from the map screen.

FIG. 5F is an example of the add a court screen the user would see if they selected the tab in FIG. 5E. The user would have options to directly enter textual information for the court, images, videos, and a location among other court information.

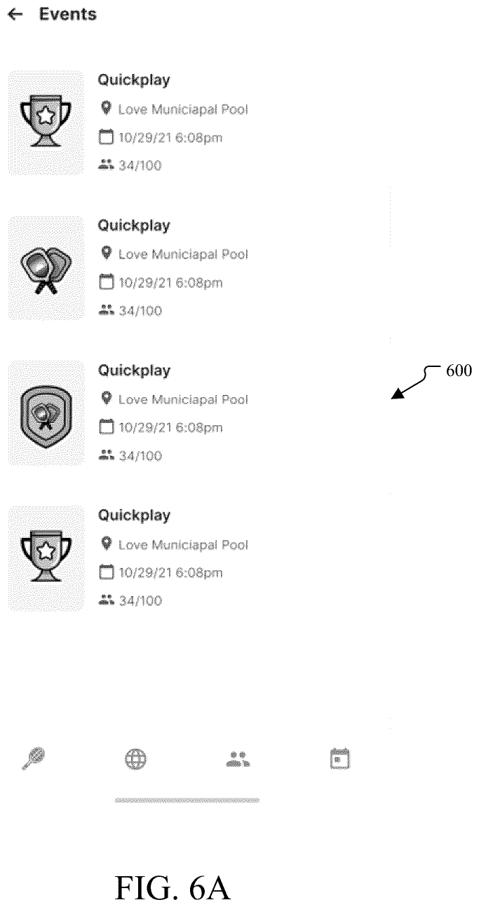

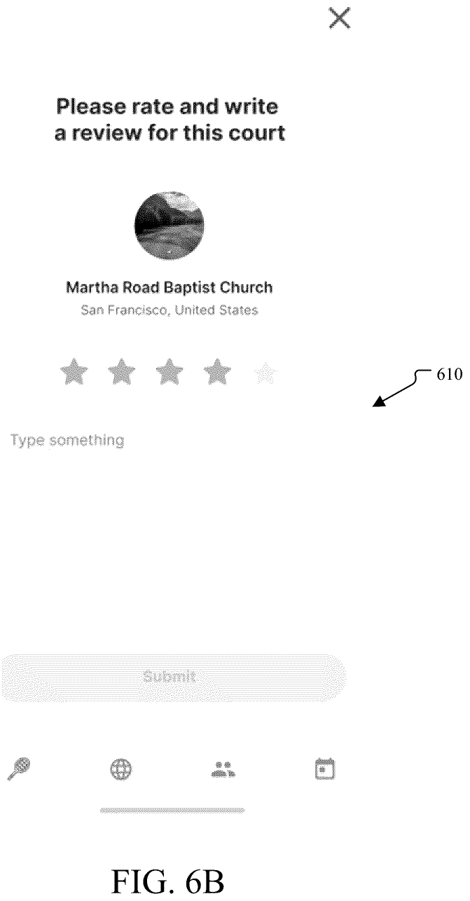

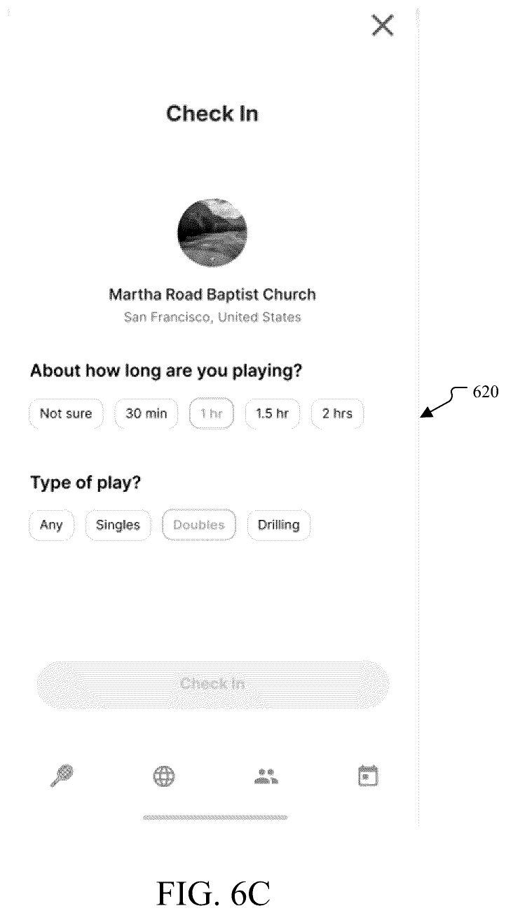

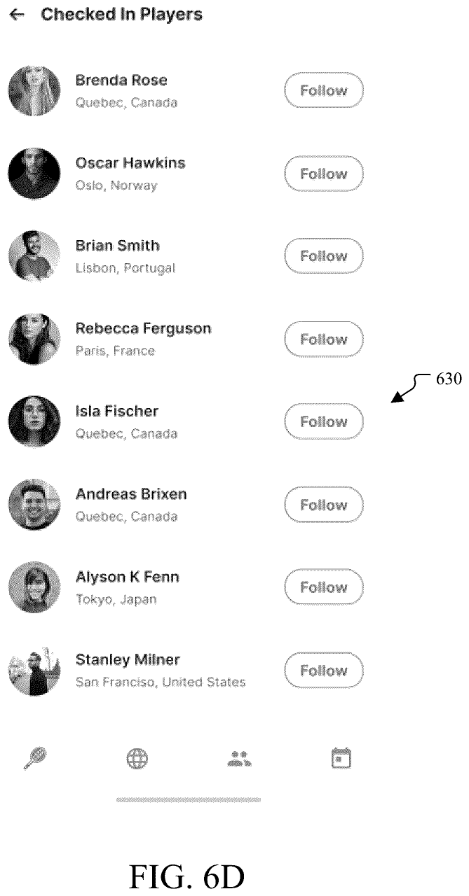

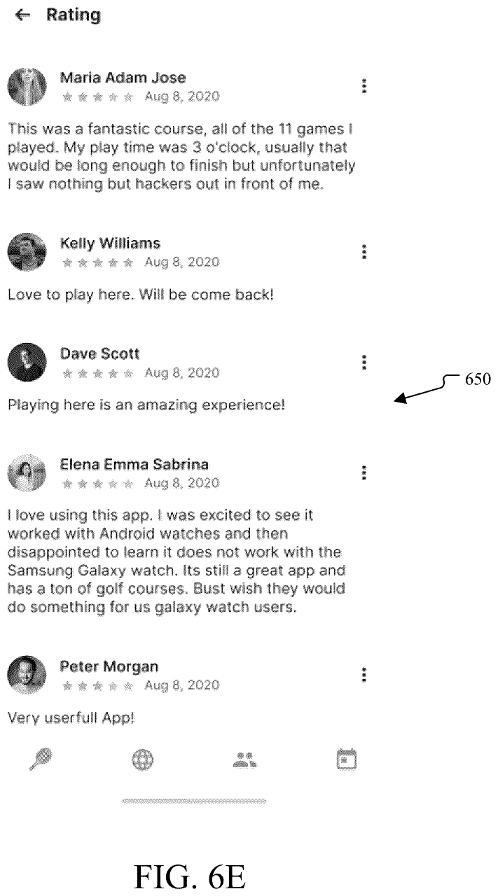

FIG. 6A is an example of the events screen in the application. Users of the application may be able to create events which are public to all users of the application or private for an invited players. Public events may be visible within a certain geographic area and/or on the feed for all users. Private groups may only be visible on this screen to invited users. The event page may include one or more tabs with the title of the event and information for the event including date, location, time, number of participants, and/or a selectable option to open the full event screen.

FIG. 6B is an example of a review screen for a court with a star rating system and an option to enter text into the field. FIG. 6C is an example of the check in screen for a user. The user may be able to input how long they are playing, set a default play time, and/or describe the type of competitive activity they are participating in. FIG. 6D is an example of a screen of checked in players at a location. The screen may include the players profile picture, name, and location among other information and a selectable option to follow the player. FIG. 6E is an example of a screen with user ratings for a location. The screen may include the star rating, date of review, user image, username, and text rating of the location as a scrollable feed for other users to view.

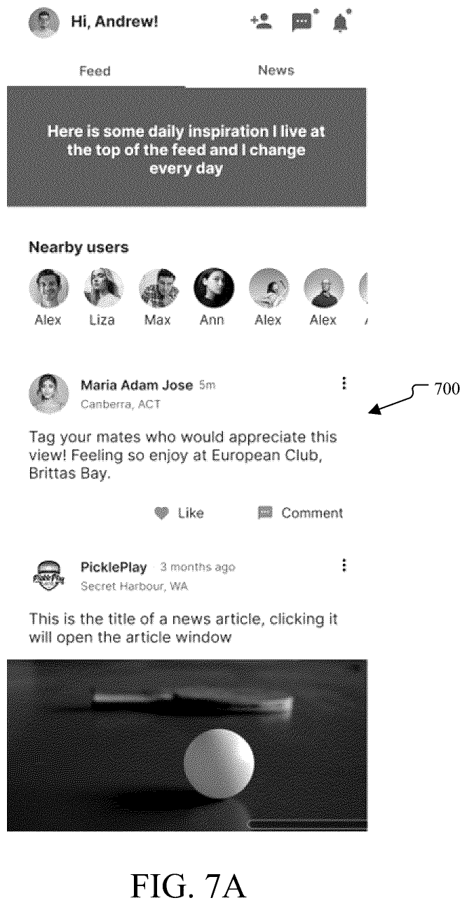

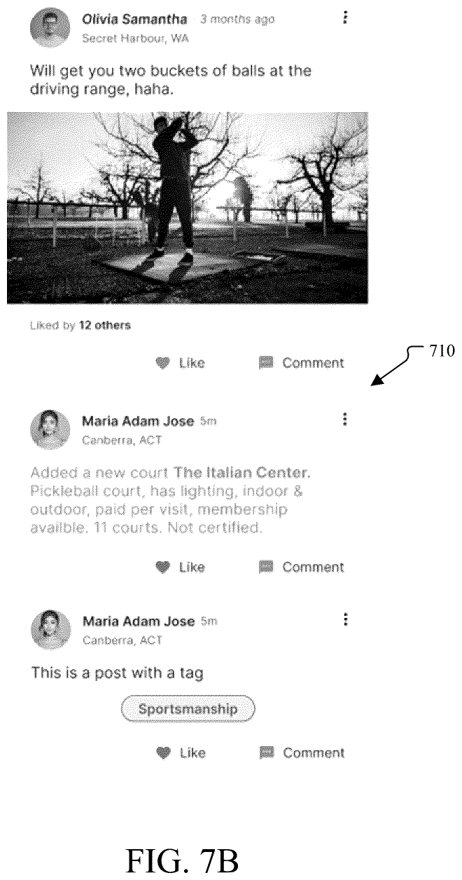

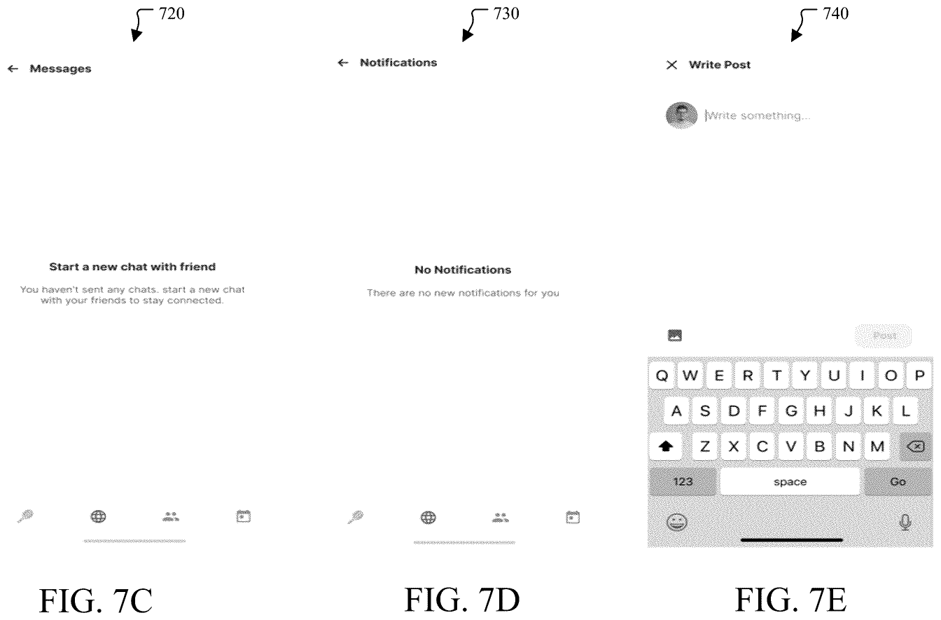

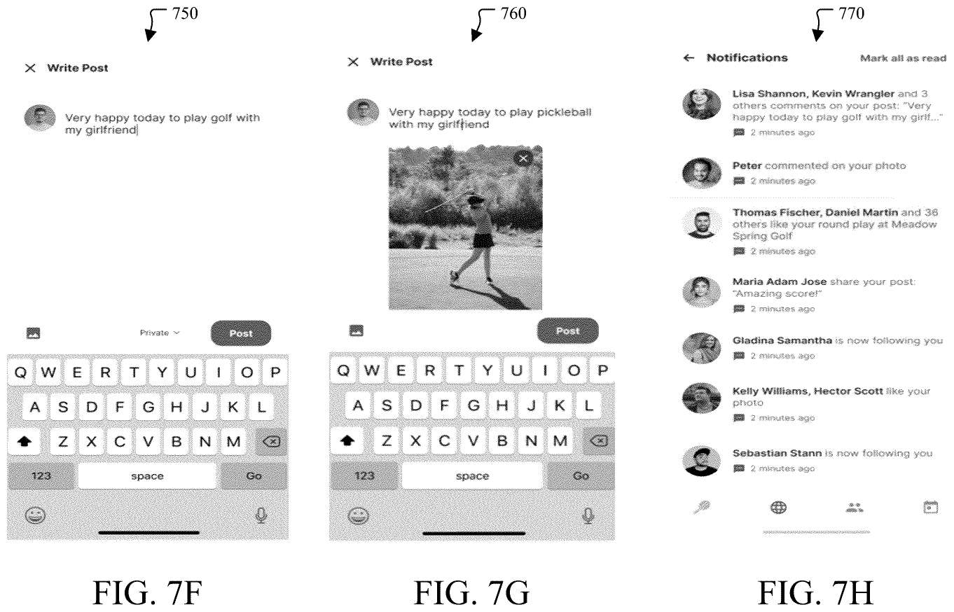

FIGS. 7A and 7B are examples of the feed that a user of the application may see on the home screen. The feed may be a scrollable series of posts from other users, the application developer, advertisers, and the user with text, images, videos, nearby users, other actions for the users, and/or advertisements each as a selectable option for the user to interact with. FIG. 7C is an example of a messages screen with no messages that a new user may see. FIG. 7D is an example of a notifications screen with no notifications that a new user may see. FIGS. 7E, 7F, and 7G are examples of posting screens where a user may write a post for display on the application feed. The screen may include the device keyboard, the user's image, prompts to input text, options to upload an image or video, and a selectable option to post the content. FIG. 7H is an example of a notifications screen where the user may see notifications of activity from their feed, other users they follow, comments on their posts, and/or recommendations for the user based on their profile settings.

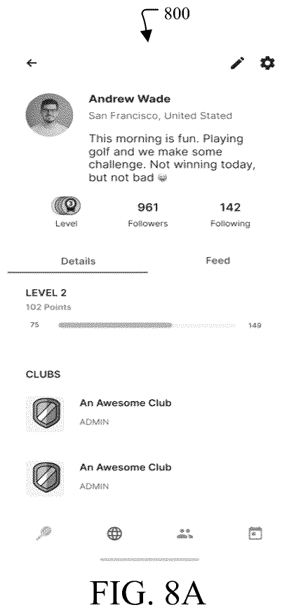

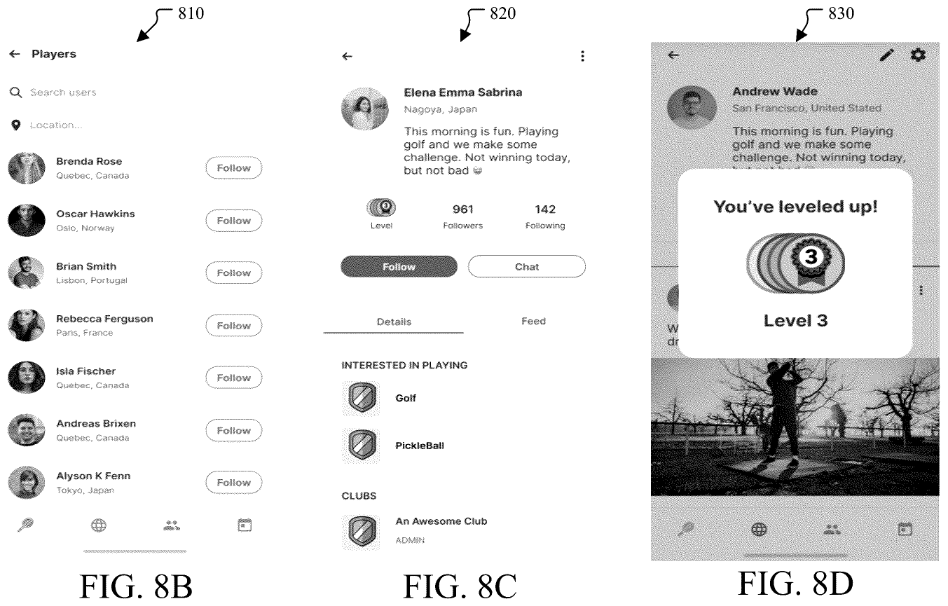

FIG. 8A is an example of a user's profile page on the application. It may include information about the user including their name, image, location, description, most recent status update, user level, skill level, number of followers, number of users following, club membership, event status, and other profile information. FIG. 8B is a user search screen where a user can look up other users by name and/or location. By inputting either a name and/or location the most relevant users based on the search criteria will be returned as selectable options to follow and connect with. FIG. 8C is an example of a player screen selected from FIG. 8B. The other user's profile page is opened with information about the user that can be viewed to determine if they would be a good partner for a competitive activity. FIG. 8D is an example of a use interface showing gamification of the application where the user has earned a reward and leveled up their user ranking. Gamification involves creating an application where users are incentivized to participate by receiving recognition and rewards in the application. Users who participate by joining clubs, going to events, setting up matches, checking in, connecting with other users, posting and responding to play requests, and/or many other activities on the application may receive rewards such as increased user levels on the application, discounts from sponsors, and other rewards to incentivize application participation.

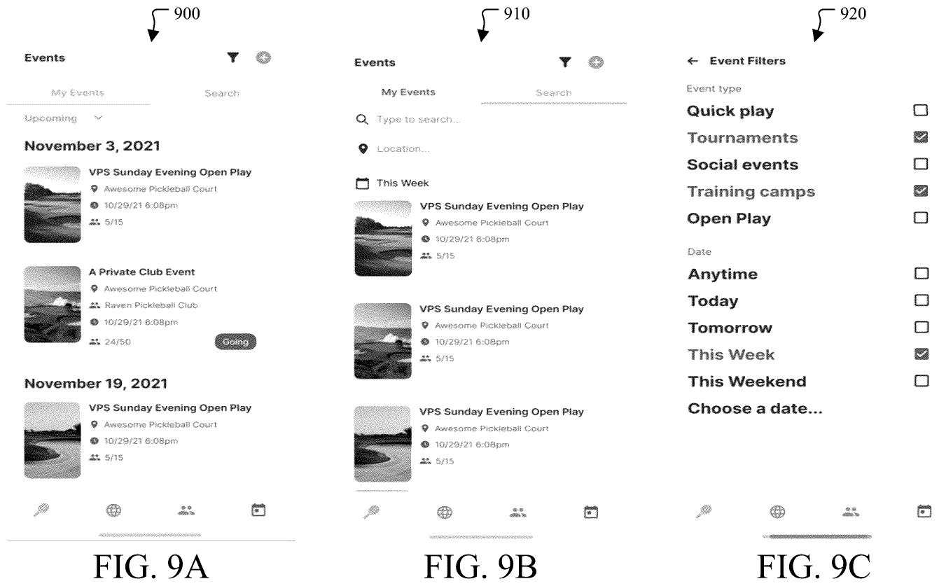

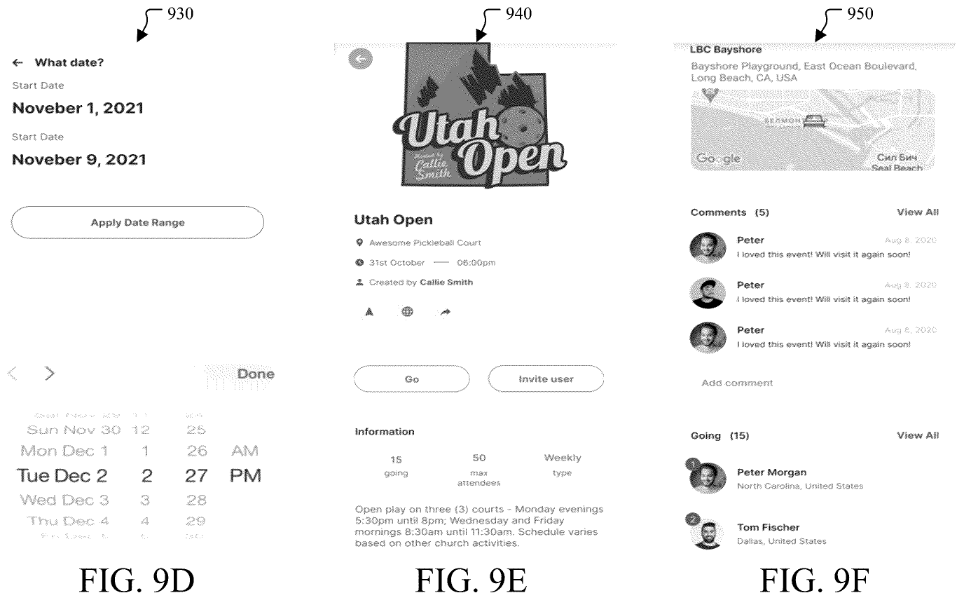

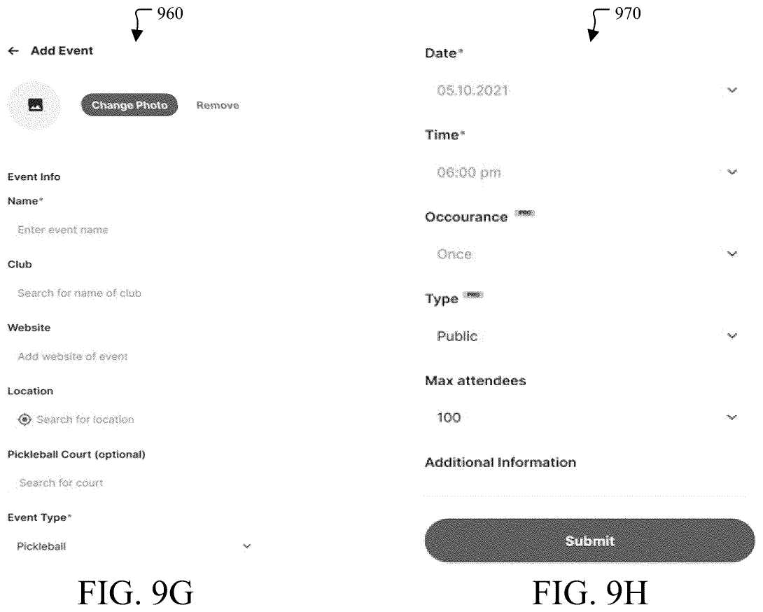

FIGS. 9A and 9B are examples of event screens where a user may see events that they are participating in and/or search other events. The events may be displayed by date along with location, time, an image of the location, event title, and/or number of participants. Users may search events by name, type of event, event keyword, and/or location. The event tabs may be selectable.

FIGS. 9C and 9D are example screens with event filters which may also be used to search events. The event filters may include event types (e.g., quick play, tournaments, social events, training camps, open play, etc.), location, competitive activity type, and/or date range. The filters may be selectable as toggles, tabs, scrolling bars, and/or check boxes.

FIGS. 9E and 9F are an example of an event screen for a created event. The screen may include event images, textual information about the event, location, date, time, number of participants, and/or selectable options to go to the event and/or invite other players. There may be comments from the organizer or other players on the screen, a list of players who are going, a list of players who are invited, and/or 98 a map showing the location.

FIGS. 9G and 9H are an example of an add event page on the application. The screen may include selectable options to add and/or remove an image, event information including name, club, website link, location, specific court or area at the location, event type, date, time, number of occurrences (e.g., single or repeating), type of event (e.g., public or private), maximum number of attendees, and additional information, as well as a selectable option to submit the information.

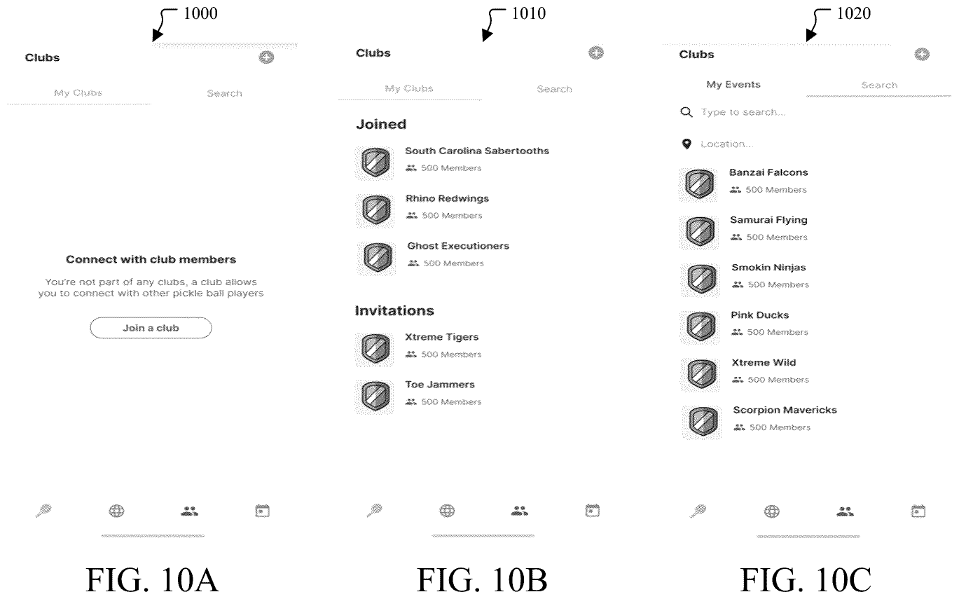

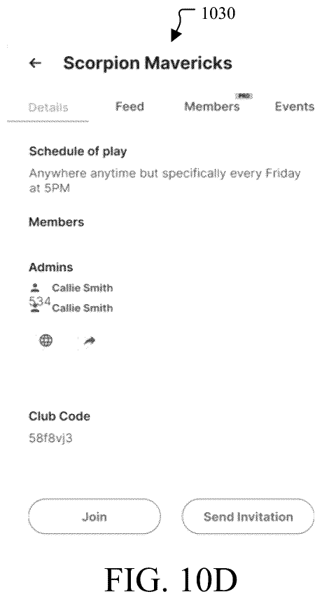

FIGS. 10A, 10B, 10C, and 10D are examples of club pages for a user. Before the user joins or creates a club, they may see an interfaced such as the one depicted in FIG. 10A with a prompt and selectable option to join a club. Once an indication that the user has joined a club is received, an interface as depicted in FIG. 10B, with the user's clubs on the “My Clubs” tab on the screen, is generated and displayed. The clubs may have images and text describing the club. There may also be an invitations field where the user may accept or reject invitations to a club via the displayed interface. FIG. 10C shows a search field interface where operable to receive a search for clubs by keyword or location. FIG. 10D is an example user interface that is displayed when a club icon is selected. The club information including details, feed, membership, events, admins, schedule of play, club code, and/or selectable options to join or send an invitation to join may be visible here.

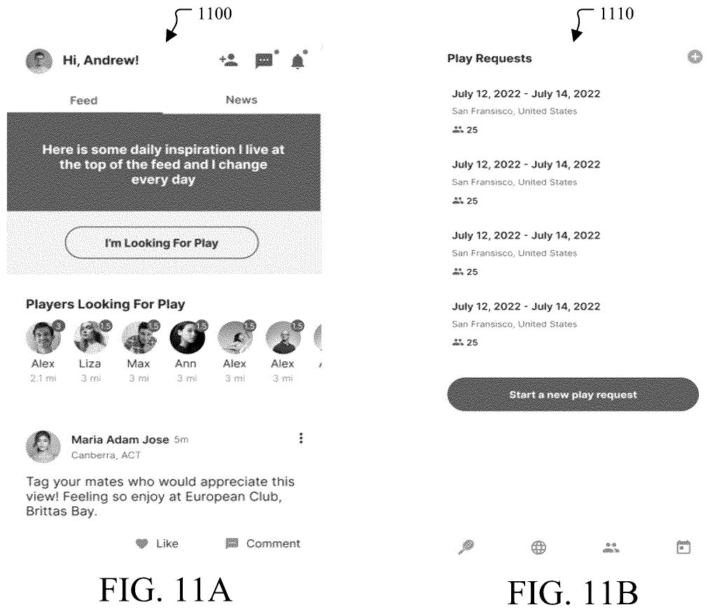

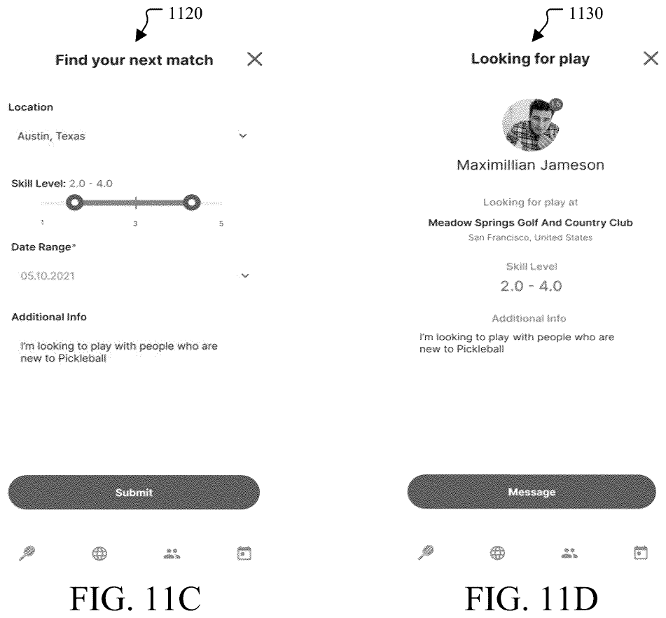

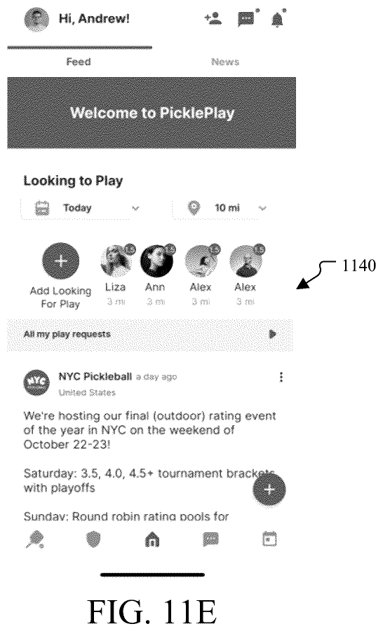

FIGS. 11A, 11B, 11C, 11D, and 11E are examples of looking for play screens that a user may utilize to enter and respond to a looking for play request. FIG. 11A is an example of the application feed with a selectable option “I'm Looking For Play” on the feed. If the user selects this option, FIG. 11B is an example of the play request screen where the user may see previous requests and/or a selectable option to start a new play request. Play requests may include date range, location, and other information. FIG. 11C is an example of the screen the user will see if the user selects the new play request option. On this screen the user may enter play request information including location, desired skill level, date range, and/or additional information and then submit the play request with the selectable option. FIG. 11D is an example screen of the completed play request that will be displayed to other users of the application to see if they want to participate. The screen may include the requesting user's profile image and name, as well as the information entered with the play request, and a selectable option to message the requesting user to set up the competitive activity. FIG. 11E is an example of an alternative embodiment of the application feed of the looking for play screen. In this embodiment in addition to a selectable option to look for play where the selectable option is a circle with a plus symbol (e.g., “+”), the user may also enter additional details in drop down menus such as the date for play and radius of search.

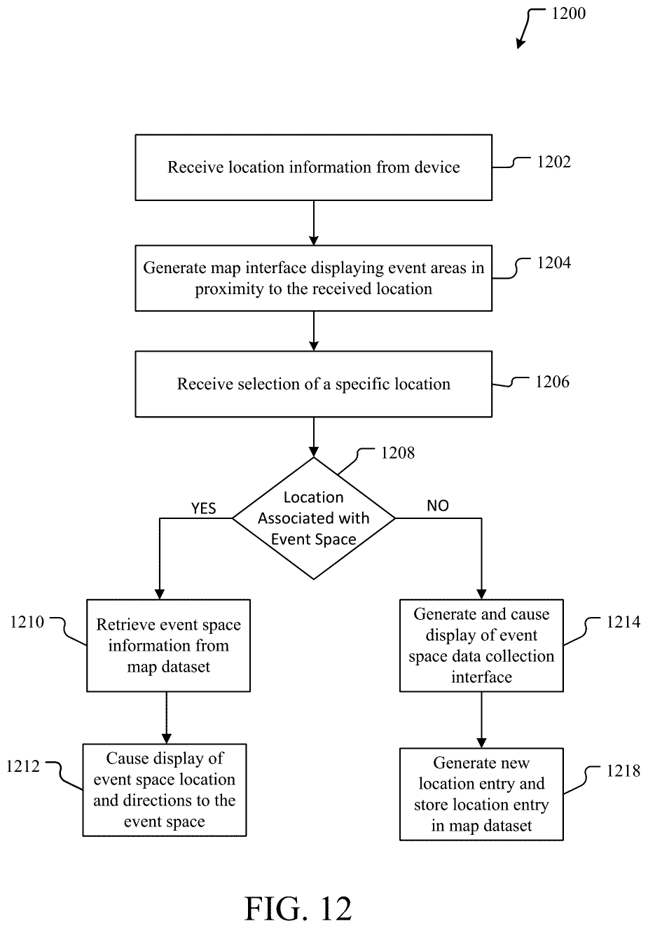

FIG. 12 is a block diagram illustrating a method 1200 for processing generating and displaying map functionality, according to aspects described herein. A general order of the operations for the method 1200 is shown in FIG. 12. The method 1200 may include more or fewer steps or may arrange the order of the steps differently than those shown in FIG. 12. The method 1200 can be executed as computer-executable instructions executed by a computer system and encoded or stored on a computer readable medium. Further, the method 1200 can be performed by gates or circuits associated with a processor, an ASIC, an FPGA, a SOC or other hardware device. Hereinafter, the method 1200 shall be explained with reference to the systems, components, devices, modules, software, data structures, data characteristic representations, signaling diagrams, methods, etc., described in conjunction with the other figures.

Flow begins at operation 1202, where location information is received from an electronic device, such as a mobile phone or a computing device. In one embodiment, when a user has provided permissions to receive location information, the location information may automatically be received when an associated application is opened on the user device, or alternatively, when the user accesses the map functionality on an application on the mobile device. Alternatively, the location information may be received in response to an explicit action received via the mobile device, such as the input of an address in a text box, activation of a user interface element to share a current location, or the like. The location information may be GPS coordinates, IP addresses, cellular data location information, location determined based upon a wireless signal scan of the local area, or the like.

At operation 1204, a map interface is generated based upon the received location. The map interface may display a predefined area around the received location information. Alternatively, the map interface may display an area scaled such that the closest event spaces to the received location information is received. In embodiments, the displayed map interface may include a number of selectable icons on the map, which each selectable icon being associated with a different relevant event space. Exemplary event spaces include, pickleball courts, basketball courts, tennis courts, soccer fields, football fields, parks, concert venues, hiking trails, movie theaters, or any other type of space capable of hosting a relevant event. Additionally, or alternatively, the map interface may include a text box operable to receive search queries for an event space.

Flow continues to operation 1206 where a specific location is received. For example, the specific location may be received via activation of a selectable element displayed on the map, via a search element (e.g., a text box, a location list, etc.) associated with the map interface, etc. Flow continues to decision operation 1208, where a determination is made as to whether the specific location is associated with a stored event space. For example, the location information can be used to perform a lookup on a map dataset storing known event spaces to determine if a corresponding event space exists.

If a known event space exists, flow branches YES to operation 1210 where the event space information is retrieved from the map dataset. Event space information may include, location information, event type(s) associated with the event space, operating hours, specific event data, pictures of the event space, etc. Upon retrieving the event space information, flow continues to operation 1212 where a display of the retrieved event space information is generated and cause to be displayed on a device. For example, an event space interface may be generated and transmitted, via a network, to a requesting device for display on the requesting device.

Returning to decision operation 1208, if a known event space is not associated with the specific location, flow branches NO to operation 1214. At operation 1214, an event space data collection interface is generated and caused to be display on the requesting device. For example, an event space data collection interface may be generated and transmitted, via a network, to a requesting device for display on the requesting device. For example, the event space data collection interface may include a number of fields which can be populated with information describing an event space. The different fields may be operable to activate different functionality on the requesting device. For example, a text field may be operable to open a soft keyboard on the mobile device, while an image filed may be operable to open a file browser to select an image for upload or activate a camera on the requesting device to take a picture of the event space. Upon collecting information via the event space data collection interface, the collected event space data is received, for example, via a network, and used to generate a new event space location at operation 1218. For example, at operation 1218, information received via the event space data collection interface may be parsed and transformed into a format compatible with the map datastore. The information is then stored and indexed in the map datastore. Exemplary map interfaces described with respect to the method 1200 are depicted in FIGS. 5A-5F.

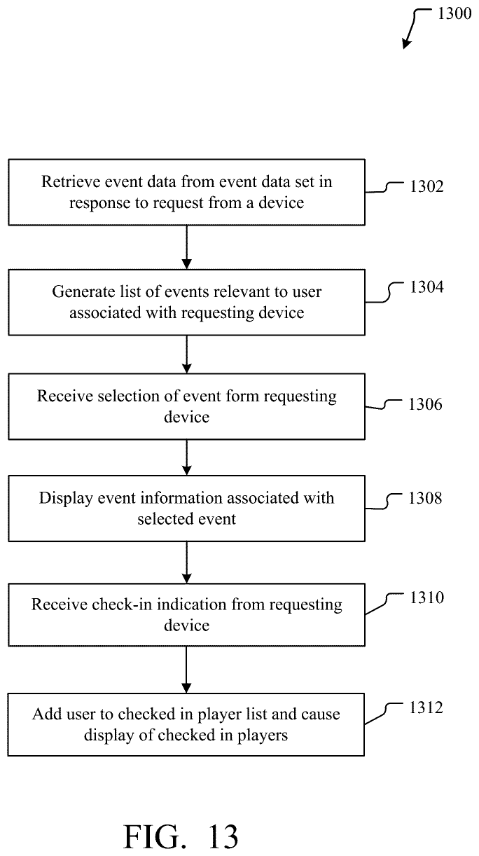

FIG. 13 is a block diagram illustrating a method 1300 for processing generating and displaying map functionality, according to aspects described herein. A general order of the operations for the method 1300 is shown in FIG. 13. The method 1300 may include more or fewer steps or may arrange the order of the steps differently than those shown in FIG. 13. The method 1300 can be executed as computer-executable instructions executed by a computer system and encoded or stored on a computer readable medium. Further, the method 1300 can be performed by gates or circuits associated with a processor, an ASIC, an FPGA, a SOC or other hardware device. Hereinafter, the method 1300 shall be explained with reference to the systems, components, devices, modules, software, data structures, data characteristic representations, signaling diagrams, methods, etc., described in conjunction with the other figures.

Flow beings at operation 1302 where a request for event data is received. For example, a request may be automatically generated by a mobile device upon receiving, via an application or web interface, of a selection of an event space or a listing of events. Upon receiving the request, an event datastore is searched to identify relevant events. Relevant events may be determined based upon a player associated with the requesting device. For example, parameters associated with the request, the requesting device, or generated and transmitted by an application on the device, can be used as keys in a datastore lookup to identify relevant events. Upon identifying relevant events, data associated with each relevant event is retrieved from an event datastore and used to generate a listing of events at operation 1304. Upon generating the listing of events, the list is transmitted to the requesting device with an instruction which causes the event list to be displayed on the device, for example, as shown in FIG. 6A.

Flow continues to operation 1306 where a selection of an event is received, for example, via receiving a selection of an event from the event list. Upon receiving a selection of the event, data associated with the event is retrieved, for example, from the event data store and caused to be displayed on the requesting device at operation at operation 1308. In one example, event information for all events in the event list may be retrieved at operation 1304. In said example, the event information may be transmitted with the event list. However, in alternate examples, in order to save bandwidth, detailed information for a specific event may be retrieved and transmitted upon selection of a specific event.

Flow continues to operation 1310, where, in response to display of a check in interface on the requesting device, check-in information is received from the requesting device. For example, an interface may be automatically generated and displayed when the user arrives at the event space. In said example, when the user's privacy settings allow for the sharing of location information, a device's real-time location can be used to determine when the device is within a predetermined perimeter of the event location. Upon entering the perimeter, an interface on the application can be displayed which will allow the user to check-in to the event and provide additional details, such as what the user will be doing, how long the user will be there, etc. The additional details and an event signal are received and processed to add the user to the event at operation 1312. In further embodiments, upon receiving a check-in indication, a list of other checked-in users may be generated, for example, by querying user locations, querying past check-ins and comparing time and/or location data with the event space, etc. and transmitted to the requesting device and caused to be displayed on the device. In doing so, the user of the requesting device will be able to see who is there, what event activities the other users are participating in, upon arrival at the event space. Exemplary event and check-in interfaces described with respect to the method 1300 are depicted in FIGS. 6A-6E.

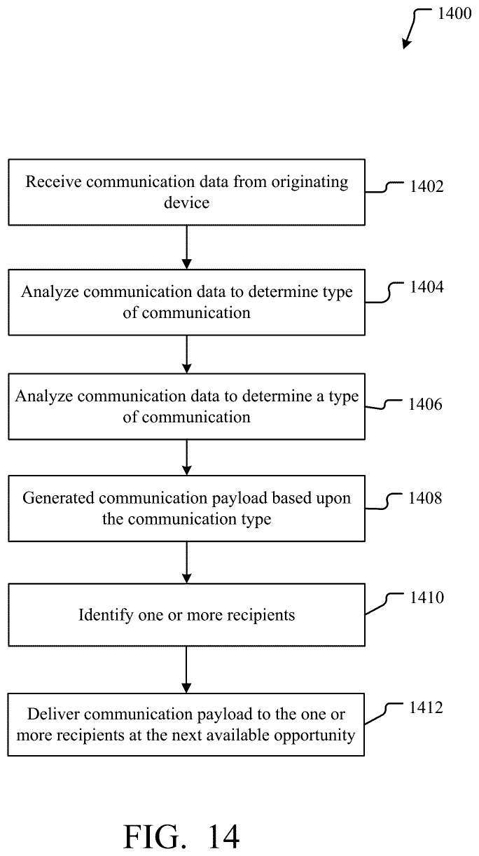

FIG. 14 is a block diagram illustrating a method 1400 for generating an event list, according to aspects described herein. A general order of the operations for the method 1400 is shown in FIG. 14. The method 1400 may include more or fewer steps or may arrange the order of the steps differently than those shown in FIG. 14. The method 1400 can be executed as computer-executable instructions executed by a computer system and encoded or stored on a computer readable medium. Further, the method 1400 can be performed by gates or circuits associated with a processor, an ASIC, an FPGA, a SOC or other hardware device. Hereinafter, the method 1400 shall be explained with reference to the systems, components, devices, modules, software, data structures, data characteristic representations, signaling diagrams, methods, etc., described in conjunction with the other figures.

Flow begins at operation 1402 where communication data is received from an originating device. For example, communication data can be received via a local interface on a mobile device or a computing device. The communication data may be text, image video, audio, or a combination of different types. The communication data received via the local interface may be packaged, along with metadata, for example, identifying the user, the type of content, an intended recipient or posting location for the content, etc., and transmitted to a central device, such as the enterprise device depicted in FIG. 1. The packaged communication data is received at operation 1402.

Flow continues to operation 1404 where the communication data, and/or, the metadata associated with the communication data, is analyzed to determine a type of communication. In embodiments, aspects of the present disclosure are operable to receive, process, and deliver various types of communications, such as direct messages between users, public postings, review postings, social media postings, etc. Different types of communications may be formatted, packaged, and/or delivered in different manners. In order to determine how to process the received communication data, it may be required to determine the type of communication at operation 1404. In one example, the type of communication may be determined based upon an indicator associated with the communication metadata. In another embodiment, the type of communication data may be determined based upon the intended recipient. For example, if the communication is directed to a single user, then it is a direct message. If the communication is directed towards the public in general, then it may be a posting on a publicly available channel. In yet another embodiment, the type of communication may be determined based upon the content of the communication data.

Flow continues to operation 1408, where, based upon the communication type, a communication payload is generated for delivery. The type of payload generated is determined based upon the communication type. For example, if the communication is a direct communication or a chat, then a direct message payload is generated for delivery to one or more recipients. In another embodiment, if, for example, the communication is a review for an event space, then a review payload is generated and added as a post to a review board. In yet another embodiment, if communication type is a social media post, then a social media payload is generated and added to the user's profile. In said example, the social media post may also be added to one or more feeds of recipients who follow the user. Under such circumstances, generating the communication payload may include grouping the communication with updates from other users into different feeds to be distributed to followers.

At operation 1410, one or more intended recipients are identified. Identification of the recipients may be different based upon the communication type. For example, in chats and direct messages, the one or more recipients may be identified by parsing the received communication data to identify intended recipients. In another embodiment, if the communication is a social media posts, the one or more recipients may be identified by determining a list of followers of the user who generated the communication. In said embodiment, the one or more recipients may be all, or a subset of, the user's followers.

Upon identifying the recipients, flow continues to operation 1412 where the communication payload is delivered to the one or more recipients at the next available opportunity. For example, upon receiving a connection request from a device associated with a recipient, the communication payload may be pushed to the recipient's device over a network. In said example, until a communication link is established with the recipient's device, the communication payload may be stored in a queue for delivery. Alternatively, or additionally, the communication payload may be delivered to a mailbox associated with the recipient. Exemplary event and check-in interfaces described with respect to the method 1300 are depicted in FIGS. 7A-7H.

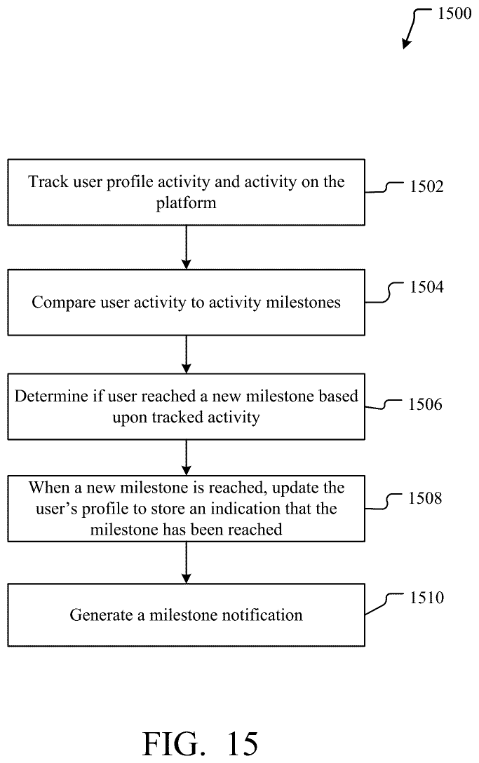

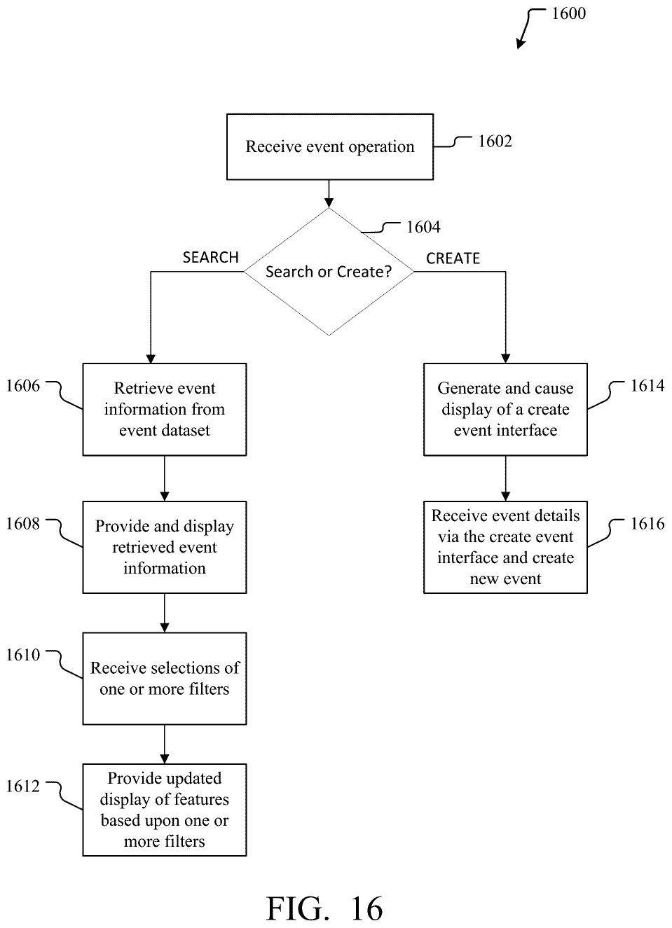

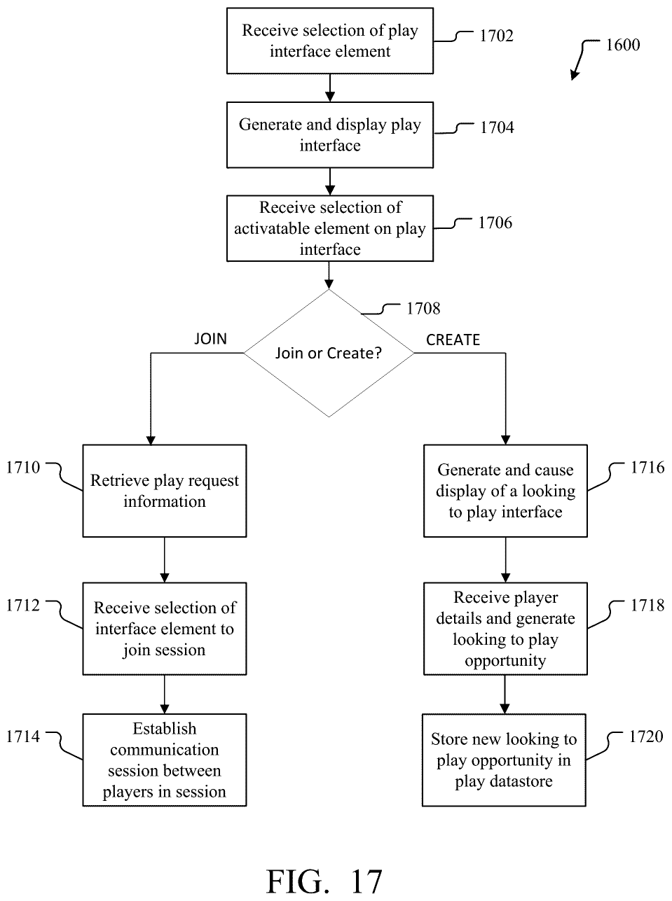

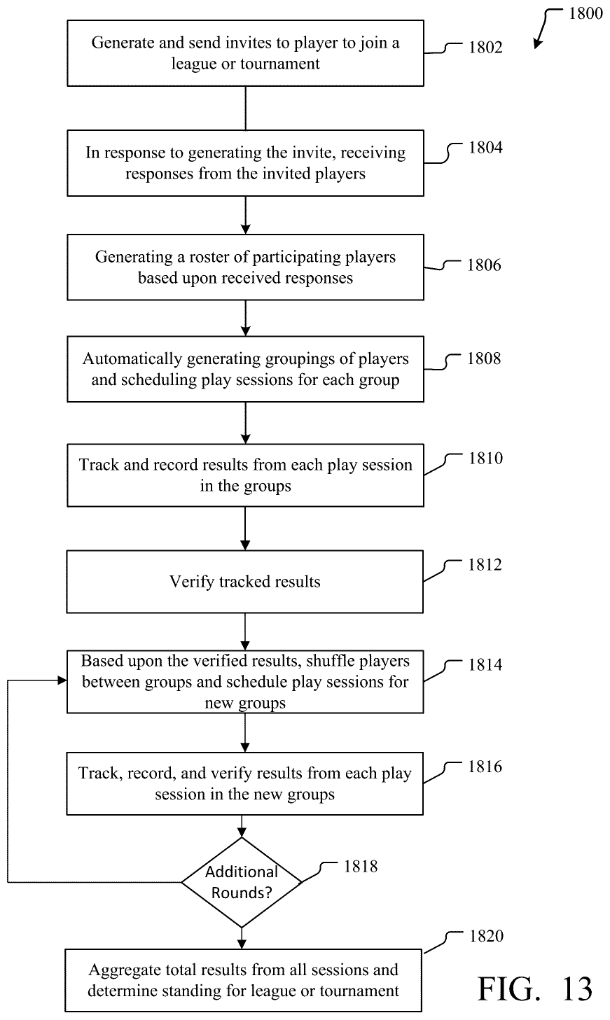

FIG. 15 is a block diagram illustrating a method 1500 for gamifying actions performed on a platform, according to aspects described herein. In examples, a platform may be an application, a website, a system, or the like. A general order of the operations for the method 1500 is shown in FIG. 15. The method 1500 may include more or fewer steps or may arrange the order of the steps differently than those shown in FIG. 15. The method 1500 can be executed as computer-executable instructions executed by a computer system and encoded or stored on a computer readable medium. Further, the method 1500 can be performed by gates or circuits associated with a processor, an ASIC, an FPGA, a SOC or other hardware device. Hereinafter, the method 1500 shall be explained with reference to the systems, components, devices, modules, software, data structures, data characteristic representations, signaling diagrams, methods, etc., described in conjunction with the other figures.

Flow beings at operation 1502, where the user's activity on the platform is tracked. In embodiments, the platform may be interacted with through various different access points, such as a website, an application, a physical location, a kiosk, etc. When a device used to access the platform receives a user action, the method 1500 creates a record of the user's action as an activity. Examples of user actions which may be tracked include, but are not limited to, creating a profile, addition friends or followers, joining activities, searching for events or event spaces, creating events or event spaces, posting reviews, generating social media posts, etc. The records may be stored in an activity log, which itself may be indexed by a globally unique ID, a user ID, or the like.

At operation 1504, a newly recorded activity is compared to activity milestones. An activity milestone may be any type of milestone predefined by the platform. Example milestones include, but are not limited to, first post, 100^{th} post, first event attended, first event created, 10^{th} event attended, 50^{th} event created, first review posted, and the like. When a new activity is recorded and added to the activity log, a lookup of the activity log can be performed to determine how many times the user performed similar activities. In said example, the query can be based upon a flagged classification associated with an activity, e.g., a “event creation,” based upon a text search of the log to identify similar activities, etc. Alternatively, or additionally, a counter or tracker for each type of activity may be maintained. When a new activity of a specific type is performed, the counter associated with that type of activity is incremented.

At operation 1506, upon recording a new activity, a determination is made as to whether performance of the new activity reaches a predefined milestone. For example, referring back to operation 1504, the results of a lookup or the current value of a counter or tracker associated with the activity can be compared against a milestone threshold. Based upon the comparison to the threshold, a determination is made as to whether the newly performed activity reached a milestone or not. For example, if the incremented counter equals a milestone threshold for an associated activity, then a milestone has been reached.

At operation 1508, when a milestone is reached, the user profile associated with the activity is updated to store an indication that a milestone has been reached. For example, there may be a record of accomplishments or a level associated with the user profile. Upon reaching a milestone, the record of accomplishments, level, or other type of record associated with the milestone is updated and added to the user profile, such that the reached milestones can be viewed by the user or other users when viewing the user's profile.

At operation 1510, a milestone notification is generated upon reaching a new milestone. In embodiments, the milestone notification can be a graphical, audio, video, or combination of media, notification that is presented to the user as a means of notifying the user that the milestone has bee reached. An exemplary milestone notification is shown in FIG. 8D.

FIG. 16 is a block diagram illustrating a method 1600 for performing event operations on a centralized event platform, according to aspects described herein. In examples, a platform may be an application, a web site, a system, or the like. A general order of the operations for the method 1600 is shown in FIG. 16. The method 1600 may include more or fewer steps or may arrange the order of the steps differently than those shown in FIG. 16. The method 1600 can be executed as computer-executable instructions executed by a computer system and encoded or stored on a computer readable medium. Further, the method 1600 can be performed by gates or circuits associated with a processor, an ASIC, an FPGA, a SOC or other hardware device. Hereinafter, the method 1600 shall be explained with reference to the systems, components, devices, modules, software, data structures, data characteristic representations, signaling diagrams, methods, etc., described in conjunction with the other figures.

Flow begins at operation 1602, where an event operation is received. In one example, an event operation is received from a remote device accessing the centralized platform. For example, an event operation may be received from a computer accessing the application via a web portal. In another example, the event operation may be received from a mobile device executing an application linked to the centralized platform. In still another example, an event operation may be received via an API interface. One of skill in the art will appreciate that event notification can be received in a number of different ways without departing from the scope of this disclosure. For sake of clarity, event operations described with respect to the method 1600 may be search operations, filter operations, or creation operations. However, one of skill in the art will appreciate that other types of event operations can be received without departing from the scope of this disclosure.

Flow continues to decision operation 1604, where the type of operation is determined. In one embodiment, the operation type can be determined based upon a request, or metadata associated with the request, to perform the operation. For example, the request can include metadata identifying an action to be performed. Alternatively, the type of operation can be determined based upon a type of instruction received at operation 1602.

When the event operation is a search operation, flow branches SEARCH to operation 1606. At operation 1606, parameters associated with the operation are used to perform a lookup in one or more event datasets to identify events related to the search. For example, key terms included in a search operation may be used to query the one or more event datasets. In addition to parameters associated with the search operation, additional parameters may also be determined and used to query the one or more search results, such as a user or account identifier associated with the search operation, current time, location of a device sending the search operation, etc. These additional parameters may be used in conjunction with the parameters associated with the search operation to retrieve event information from one or more datasets at operation 1606.

At operation 1608, the retrieved event information is used to generate an event results package. The event results package can include one or more different events identified by the parameters used to search the one or more datasets. In embodiments, the package may format the event results to best fit a form factor of a device or application which originally sent the event operation. For example, the method 1600 may identify a type of device or application sending the request, determine the form factor associated with the device or application, and format the events for display on the determined form factor (e.g., formatted the results to be displayed in a webpage, formatted for display on a mobile device, formatted for an email, etc.). At operation 1608, the results package is provided (e.g., sent over a network) to the device or application that generated the event operation with an instructions to display the event results.

In some embodiments, the event results may need to be refined. For example, a large number of results may be returned, or additional information is needed to clearly identify a specific event. Accordingly, the event results may be refined through a filtering process. At operation 1608, a selection of one or more filters may be received. In examples, the event results may be refined by applying the one or more filters in order to generate refined event search results. In one example, the refined search results may be generated by removing events from the initial set of event results based upon the one or more filters, by performing a new search of the one or more event datastores based upon the one or more filters, or a combination of both. At operation 1612, the refined search results are provided for display, for example, by generating and providing a refined search results package. As previously described, the refined event results package can include one or more different events identified by the parameters used to search the one or more datasets. In embodiments, the package may format the refined event results to best fit a form factor of a device or application which originally sent the event operation. For example, the method 1600 may identify a type of device or application sending the request, determine the form factor associated with the device or application, and format the refined event results for display on the determined form factor (e.g., formatted the results to be displayed in a webpage, formatted for display on a mobile device, formatted for an email, etc.).

FIG. 17 is a block diagram illustrating a method 1700 for generating an event list, according to aspects described herein. A general order of the operations for the method 1700 is shown in FIG. 17. The method 1700 may include more or fewer steps or may arrange the order of the steps differently than those shown in FIG. 17. The method 1700 can be executed as computer-executable instructions executed by a computer system and encoded or stored on a computer readable medium. Further, the method 1700 can be performed by gates or circuits associated with a processor, an ASIC, an FPGA, a SOC or other hardware device. Hereinafter, the method 1700 shall be explained with reference to the systems, components, devices, modules, software, data structures, data characteristic representations, signaling diagrams, methods, etc., described in conjunction with the other figures.

Returning to decision operation 1604, if the event operation is a create operation, flow branches CREATE to operation 1614. At operation 1614, a create event interface is generated and transmitted to the device or application which originated the event operation. In example, the create event interface is operable to receive information about an event in various different formats (e.g., text, images, video, HTML, XML, a combination of formats, etc.). FIGS. 9G and 9H depict exemplary event creation interfaces.

At operation 1616, one or more event details are received via the generated create event interface. The one or more event details are used to create a new event that is stored in one or more event datastores. The newly created event can be indexed and stored in the one or more datastores such that the newly created event can be identified in future search operations. Exemplary search, filter, and event creation interfaces described with respect to the method 1600 are depicted in FIGS. 9A-9H.

FIG. 17 is a block diagram illustrating a method for generating an event list, according to aspects described herein. A general order of the operations for the method 1700 is shown in FIG. 17. The method 1700 may include more or fewer steps or may arrange the order of the steps differently than those shown in FIG. 17. The method 1700 can be executed as computer-executable instructions executed by a computer system and encoded or stored on a computer readable medium. Further, the method 1700 can be performed by gates or circuits associated with a processor, an ASIC, an FPGA, a SOC or other hardware device. Hereinafter, the method 1700 shall be explained with reference to the systems, components, devices, modules, software, data structures, data characteristic representations, signaling diagrams, methods, etc., described in conjunction with the other figures.

Flow begins at operation 1700, where a selection of a play interface element is selected. In examples, when generating a feed, for example, on a social media platform, an interactive user interface element may be included in the feed which is selectable to display opportunities to join in a play session with other users. For example, the interactive element displayed in the feed may be operable to allow users to join an online gaming session, to connect users to other users to establish a real-world game (e.g., set up a pickleball match), or the like. Although described with respect to starting a play session, one of skill in the art will appreciate that other types of activities, such as communication sessions, watch parties, etc., can be employed by the method 1700 without departing from the scope of this disclosure. An example interface displaying the selectable element in a user's feed is depicted in FIG. 11A.

Upon receiving a selection of the play interface element, flow continues to operation 1704 where a play interface is generated and caused to be displayed on the user device. The play interface may include a number of different users or game sessions which are selectable to join. Additionally, the play interface can include a new play request selectable user interface element which is operable to create a new play request, which in turn can be displayed as a selectable session. Each of the elements displayed in the play interface may be selectable, that is, can receive user interaction to either provide more detail about a selected user or game session or generate a new interface which is operable to receive input used to create a new play request. An exemplary play interface is depicted in FIG. 11B. A selection of one of the activatable elements is received at operation 1706.

In response to receiving a selection of the activatable element, flow continues to decision operation 1608 where a determination is made as to whether the received selection relates to joining or viewing an existing play request or creating a new play request. When an existing play request is determined, flow branches JOIN to operation 1710.

At operation 1710, information about a selected play session is retrieved and a user interface is generated which contains the play information. As previously discussed, the format of the interface generated at operation 1710 may be dynamically determined based upon the type of device which received selection of the activatable element. In examples, the generated interface can include information about the game session, such as location, time, players involved, game or games involved, player's skill levels, and the like. This information is helpful to a user when determining if the game session matches the user's desire to play and to ensure that the user has an appropriate skill level to join the session. The interface may also include an interactive element which is operable to join the user to the game session. An exemplary interface associated with operation 1710 is depicted in FIG. 11D.

In embodiments, user skill level may be determined automatically based upon past performance (e.g., win records, scores, etc.) or may be manually set by the individual players. In some embodiments, the method 1700 may restrict players from viewing or joining available game sessions when the user's skill level is not appropriate for the session (e.g., too high skilled or too low skilled). In said embodiments, the game session may not be displayed at all. Alternatively, the game session information may still be displayed, however, the interactive element to join the game session may be deactivated or may not be displayed in the interface.

At operation 1712, upon receiving a selection of the interactive element to join the gaming session, the user is added to the gaming session. In examples, adding the user to the gaming session can include, but is not limited to, adding the user to the gaming session record, adding the user to an online session of the game, sending a notification to the other users that a user wishes to join the game, which may or may not require permission from the other users to join, or the like. At operation 1714, a communication session is established between the device which received the selection of the interactive element and devices associated with one or more other players associated with the gaming session. In one example, the user may be added to an online lobby with the other players. In another example, the user may be directed towards a message board to communicate with the other players. In still another example, the user may be joined to a call or audio session. In still another example, an interface to generate or send a message may be displayed, which will allow the user to directly send messages to the other players without exposing personal information (e.g., phone numbers, email addresses, etc.). In examples, the device performing the method 1700 may act as a communication hub, as previously described herein, to facilitate communications between users in the gaming session.

Returning to operation 1708, when the received selection relates to create a new play session, flow branches CREATE to operation 1716. At operation 1716, an interface operable to create a new play session is generated and provided to the device which received the request to create a new play session. The create interface generated at operation 1716 is operable to receive information about the player creating the session, such as name or handle, skill level, location, etc., information about the game, such as game type, location, time of game session, etc., and any other details relevant to the game session. In some embodiments, known information, such as user's skill level, location, etc., may be prepopulated in some of the create interfaces fields. However, even if the information is prepopulated, the prepopulated data can be edited to account for changes, for example, if the player is traveling. An exemplary interface for creating a game session is depicted in FIG. 11C. Information about the player and/or game session is received via the interface at operation 1718. For example, information collected on a remote device displaying the interface can be transmitted to the device, via a network, at operation 1718. At operation 1720, the received information is used to generate a new game session opportunity (e.g., a looking to play opportunity) and store in a game session datastore, such that the game session opportunity can be displayed to other interested users.

As described herein, aspects of the present disclosure provide a centralized system for providing a social network related to events or event activities, manage communications between users on the social network, identify event spaces and event opportunities, and facilitate game play session between users. The systems and methods disclosed herein can be further leveraged to manage game leagues or tournaments in a centralized system. In doing so, among other benefits, players across wide geographic areas can be linked to participate in tournaments across the country or across the globe in a centralized system which provides for the automatic, real-time, or near real-time pushing of updates and displaying of results to all players involved in the league or tournament. Additionally, aspects of the disclosure facilitate the management of leagues and tournaments, thereby providing and effective, reliable way of storing and sharing outcomes and results in a manner that is verifiable to users of the platform.

FIG. 18 is a block diagram illustrating a method 1800 for the centralized and verifiable management of league or tournament using a data platform, according to aspects described herein. A general order of the operations for the method 1800 is shown in FIG. 18. The method 1800 may include more or fewer steps or may arrange the order of the steps differently than those shown in FIG. 18. The method 1800 can be executed as computer-executable instructions executed by a computer system and encoded or stored on a computer readable medium. Further, the method 1800 can be performed by gates or circuits associated with a processor, an ASIC, an FPGA, a SOC or other hardware device. Hereinafter, the method 1800 shall be explained with reference to the systems, components, devices, modules, software, data structures, data characteristic representations, signaling diagrams, methods, etc., described in conjunction with the other figures.

For clarity of discussion, embodiments of the method 1800 are described with respect to managing a Pickleball league or tournament. However, one of skill in the art will appreciate that the method 1800 can be modified to work with other types of sports or games, both online and offline, without departing from the scope of this disclosure.

Flow begins at operation 1802 where electronic invites are generated and sent to players or teams to participate in a league or tournament. In examples, an electronic message is generated and transmitted to a plurality of invited players or teams. In one example, the electronic message can be an email. In another example, the electronic message can be a posting to a social network. In still another example, the electronic message can be a push notification to an application. Any type of electronic message operable to include interactive elements which can be activated to join the league or tournament can be generated and sent at operation 1802.

Flow continues to operation 1804 where, in response to sending the electronic invites, responses are received at the system performing the method 1800. In examples, the electronic messages generated at operation 1802 are operable to generate and transmit an electronic response upon receiving activation of an interactive element contained within the electronic message. For example, the electronic invite may include a button to “Join” or “Decline” the invite, which, when activated, automatically generate a response that is received at operation 1804. The response may include information about the player or team that is received manually, for example, via input fields included in the electronic invite, or may be automatically populated based upon stored information on the system about the player or team. A response window (e.g., an hour, a week, a month, etc.) may be associated with operation 1804, such that flow will automatically proceed to operation 1806 upon termination of the response window.

At operation 1806, a roster of participating players or teams is automatically generated and stored in a league or tournament datastore. The league or tournament datastore may be a persistent datastore that is used to track results of the league or tournament play, individual player statistics, etc., as players and teams participate in the league. In embodiments, each player or team that responded to the invite positively, e.g., agreed to join, will be added to the league or tournament datastore. The player and/or team information stored in the league or tournament datastore is then used to generate a roster of participating players, for example, by querying and retrieving information about the players from the datastore.

Upon generating the roster, flow continues to operation 1808, where groupings of players are generated based upon the roster data. In one example, the groupings of players may be randomly generated without considering additional factors, such as skill level. For example, if the players of similar skill level are originally invited, a complete random grouping of players may be appropriate for the tournament or league. Referring to Pickleball as an example, a grouping of players may be four players which are assigned to a specific court. In other examples, player skill may be factored into the groupings. In said examples, roster information stored in the league or tournament datastore is analyzed to initially group players into different levels. After the initial grouping, random sub-groups of players may be generated for each level. Again, using Pickleball as an example, different courts or different event spaces may be used for groups of different levels. The players assigned to each court or event space may still be placed into random groups of four.

After generating the random groups, as schedule of games is automatically generated in accordance with the tournament or league format. For example, in a Pickleball league, each group of four may play in a round robin. Upon generating the schedule, the method 1800 automatically generates and sends an individualized schedule to each player or team in the tournament in order to facilitate the start of the tournament or league.

As play progresses, flow continues to operation 1810 where the results and individual performance of each game and each participant is tracked and stored in the tournament database. In one example, the results may be tracked by receiving data from each player participating in a game. This data may be automatically collected, for example during online play. Alternatively, upon completion of the match, a notification may be generated and caused to be displayed on each participants device, asking the participant to provide information about the outcome of the game. Alternatively, an admin user may be set of a league or tournament. In said embodiment, a notification to the admin user may be generated upon completion of the game which requires the admin user, such as a tournament manager or official, to provide information about the results.

Upon storing the results, flow continues to operation 1812 where the results are verified. In one example, the verification process can include pushing a notification of the results to each player or team involved in the game. The notification will include an interactive element which allows the players or team to select to confirm the results. Alternatively, or additionally, the notification can include an interactive element which allows the players or teams to challenge the results. Upon agreement of every player involved, the results can be considered verified. Alternatively, a notification of the results may be sent to a device of an official or league or tournament manager which requires them to verify the results.

Upon verifying the results, flow continues to operation 1814, where the results are analyzed to determine the top performer and bottom performer in each group. Determination performance is dependent upon the type of game being facilitated. As such, one of skill in the art will appreciate that different types of algorithms and evaluations can be applied, depending upon the sport, the game, the rules, or a combination, in order to determine the top and bottom performer of each group. Based upon the performance rankings, the groups are reshuffled, and a new round of gameplay is scheduled. For example, in a Pickleball league, different courts may be associated with different levels. Upon completion of a round robin session on each court, the top performer on a court may be grouped with a court a level higher and the bottom performer may be grouped with a court a level lower.

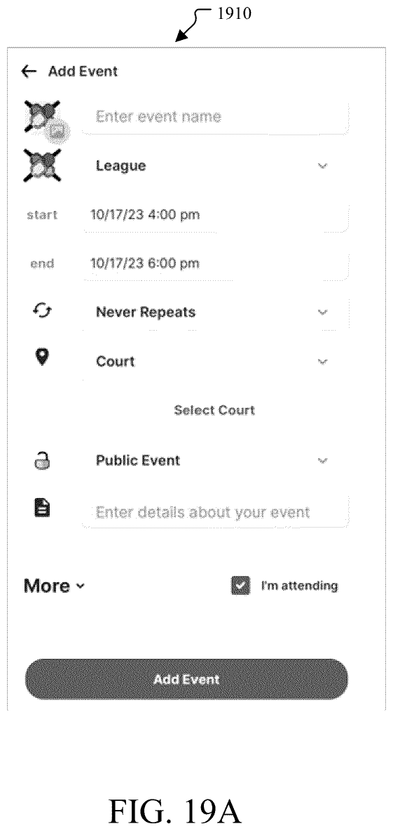

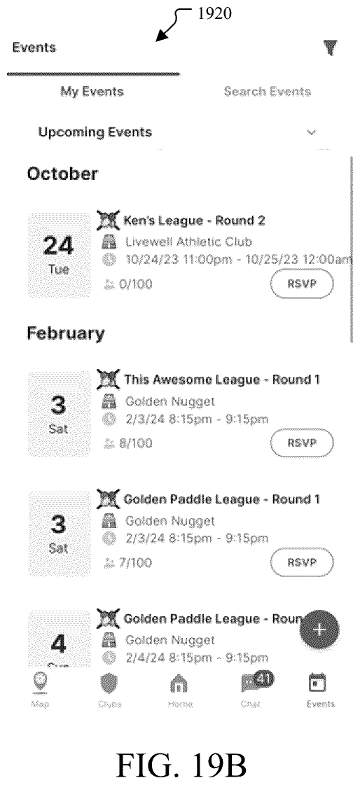

Upon establishing a new grouping, flow continues to operation 1816 where the scheduled games for the new groups are performed, results are tracked, and verified, as previously described. Upon completion of the next set of games, flow continues to operation 1818 where a determination is made as to whether or not additional rounds of the league or tournament are to be played. For example, information about the league or tournament in the league or tournament datastore is queried to determine if the format requires additional games. If so, flow branches YES and returns to operation 1814, where new groups are created based upon prior results, new games are scheduled, and the tournament continues. Otherwise, flow branches NO to operation 1820 where the overall results of players and teams participating in the tournament are retrieved from the league or tournament datastore and aggregated. The aggregated results are evaluated, according to league or tournament rules, to determine league outcomes. Notifications are automatically generated and delivered to participants in the league or tournament. An example interfaces for browsing or creating leagues or tournaments are depicted FIGS. 19A-19B.

FIG. 19A is an exemplary user interface for creating a league or tournament. In examples, the league or tournament user interface 1910 includes fields for entering a league name, selecting a league type (e.g., league or tournament), providing dates for league or tournament play, setting the league or tournament as a public event (anyone can join) or a private event (only specific invitees can join), and whether the league or tournament is repeatable (including a cadence for repeating (e.g., quarterly, monthly, weekly, etc.). Further details, such as a text description, location, rules, format, pictures of event spaces, etc., can also be added to using the league or tournament interface 1910.

FIG. 19B is an exemplary user interface for searching for leagues or tournaments. In examples, the league or tournament search interface 1920 can include listings of various leagues or tournaments. In example, the list may be populated in response to a search result, or may be automatically populated based upon device location, user preferences associated with a device, etc. The exemplary user interface 1920 may display a number of selectable leagues or tournaments. Upon receiving a selection of a specific league or tournament, further additional information for the selected league or tournament may be displayed. In further embodiments, each league or tournament listed may include an RSVP button associated with the event. The RSVP button is operable to automatically register the user for the league or tournament.

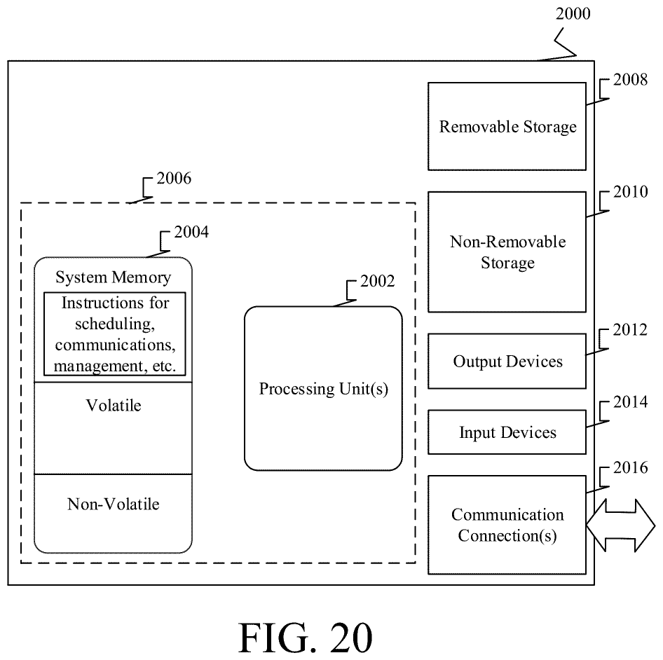

FIG. 20 illustrates a simplified block diagram of a device with which aspects of the present disclosure may be practiced in accordance with aspects of the present disclosure. The device may be a mobile computing device, for example. One or more of the present embodiments may be implemented in an operating environment 2000. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 2000 typically includes at least one processing unit 2002 and memory 2004. Depending on the exact configuration and type of computing device, memory 2004 (e.g., instructions for performing the operations as disclosed herein) may be volatile (such as RAM), non-volatile (such as ROM, flash memory, etc.), or some combination of the two. This most basic configuration is illustrated in FIG. 20 by dashed line 2006. Further, the operating environment 2000 may also include storage devices (removable, 2008, and/or non-removable, 2010) including, but not limited to, magnetic or optical disks or tape. Similarly, the operating environment 2000 may also have input device(s) 2014 such as remote controller, keyboard, mouse, pen, voice input, on-board sensors, etc. and/or output device(s) 2012 such as a display, speakers, printer, motors, etc. Also included in the environment may be one or more communication connections 2016, such as LAN, WAN, a near-field communications network, a cellular broadband network, point to point, etc.

Operating environment 2000 typically includes at least some form of computer readable media. Computer readable media can be any available media that can be accessed by the at least one processing unit 2002 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal. In examples, computer storage media is an example of non-transitory media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 2000 may be a single computer operating in a networked environment using logical connections to one or more remote computers. The remote computer may be a personal computer, a server, a router, a network PC, a peer-to-peer device or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
providing a remote device access, via a network, to a social network platform, wherein the social network platform is associated with a type of activity, and wherein the social network;
receiving, via activation of a selectable user interface element included in a user's feed, a request to view game sessions;
in response to receiving the request, generating a list of available gaming sessions, wherein the list of available gaming sessions comprises one or more activable elements associated with one or more gaming sessions in the list of available gaming sessions;
receiving an indication of selection of an activatable element in the list of available gaming sessions;
when the activatable element is associated with joining a gaming session:
retrieving, from a gaming session datastore, information related to the gaming session; and
providing the information related to the gaming session; and
facilitating communication, via the social network platform, between two or more players associated with the gaming session.

2. The system of claim 1, wherein facilitating communication comprise generating and sending direct messages between the two or more players.

3. The system of claim 1, wherein the set of operations further comprises:
receiving location information from the remote device;
based upon the received location information, generating a map interface displaying one or more event areas within a proximity of the received location, wherein the one or more event areas are represented by activatable icons on the map interface; and
receiving, via the map interface, a specific location.

4. The system of claim 3, wherein the set of operations further comprise:
determining whether the specific location is associated with an existing event space; and
when the specific location is not associated with the existing event space:
generating an event space data collection interface;
receiving, via the event space data collection interface, new event space information; and
generating a new location entry in an event space dataset, wherein the new location entry comprises the new event space information.

5. The system of claim 1, wherein the set of operations further comprises:
generating list of events relevant to a user of the social network platform;
receiving a selection of a first event from the list of events;
in response to receiving the selection, causing display of event information associated with the first event;
receiving, via an interactable check-in user interface element associated with the event information, and indication that the user of the social network has checked-in to the event; and
adding the user to a list of users associated with the first event.

6. The system of claim 1, wherein the set of operations further comprises:
receiving communication data from the remote device; and
analyzing the communication data to determine a type of communication.

7. The system of claim 6, wherein the set of operations further comprises:
generating a communication payload based upon the type of communication; and
identifying one or more recipients of the communication data; and
transmitting the communication payload to the one or more recipients.

8. The system of claim 1, wherein the set of operations further comprises:
receiving a list of invitees to a league, the list of invitees comprising a plurality of players;
sending invites to each of the plurality of players, wherein an invite includes an activatable user interface element which, upon activation, generates a response to the invite;
in response to sending the invites, receiving a plurality of join responses, wherein users associated with the plurality of join responses are added to a league dataset.
upon expiration of a predetermined time, generating a roster of players based upon the plurality of users added to the league dataset; and
randomly generating two or more groupings of the plurality of users added to the league dataset; and
for each or the two or more groupings, automatically generating a schedule of gaming sessions.

9. The system of claim 8, wherein the set of operations further comprises:
tracking results from a gaming session; and
verifying the results of the gaming session, wherein verifying the results comprises generating and delivering a notification to devices associated with players in the gaming session, wherein the notification is operable to receive confirmation of the results.

10. A method comprising:
providing a remote device access, via a network, to a social network platform, wherein the social network platform is associated with a type of activity, and wherein the social network;
receiving, via activation of a selectable user interface element included in a user's feed, a request to view game sessions;
in response to receiving the request, generating a list of available gaming sessions, wherein the list of available gaming sessions comprises one or more activable elements associated with one or more gaming sessions in the list of available gaming sessions;
receiving an indication of selection of an activatable element in the list of available gaming sessions;
when the activatable element is associated with joining a gaming session:
retrieving, from a gaming session datastore, information related to the gaming session; and
providing the information related to the gaming session; and
facilitating communication, via the social network platform, between two or more players associated with the gaming session.

11. The method of claim 10, wherein facilitating communication comprise generating and sending direct messages between the two or more players.

12. The method of claim 10, further comprising:
receiving location information from the remote device;
based upon the received location information, generating a map interface displaying one or more event areas within a proximity of the received location, wherein the one or more event areas are represented by activatable icons on the map interface; and
receiving, via the map interface, a specific location.

13. The method of claim 12, further comprising:
determining whether the specific location is associated with an existing event space; and
when the specific location is not associated with the existing event space:
generating an event space data collection interface;
receiving, via the event space data collection interface, new event space information; and
generating a new location entry in an event space dataset, wherein the new location entry comprises the new event space information.

14. The method of claim 10, further comprising:
generating list of events relevant to a user of the social network platform;
receiving a selection of a first event from the list of events;
in response to receiving the selection, causing display of event information associated with the first event;
receiving, via an interactable check-in user interface element associated with the event information, and indication that the user of the social network has checked-in to the event; and
adding the user to a list of users associated with the first event.

15. The method of claim 10, further comprising:
receiving communication data from the remote device; and
analyzing the communication data to determine a type of communication.

16. The method of claim 15, further comprising:
generating a communication payload based upon the type of communication; and
identifying one or more recipients of the communication data; and
transmitting the communication payload to the one or more recipients.

17. The method of claim 10, further comprising:
receiving a list of invitees to a league, the list of invitees comprising a plurality of players;
sending invites to each of the plurality of players, wherein an invite includes an activatable user interface element which, upon activation, generates a response to the invite;
in response to sending the invites, receiving a plurality of join responses, wherein users associated with the plurality of join responses are added to a league dataset.
upon expiration of a predetermined time, generating a roster of players based upon the plurality of users added to the league dataset; and
randomly generating two or more groupings of the plurality of users added to the league dataset; and
for each or the two or more groupings, automatically generating a schedule of gaming sessions.

18. The method of claim 17, further comprising:
tracking results from a gaming session; and
verifying the results of the gaming session, wherein verifying the results comprises generating and delivering a notification to devices associated with players in the gaming session, wherein the notification is operable to receive confirmation of the results.

19. A non-transitory computer storage media comprising computer executable instructions that, when executed by at least one processor, perform a method comprising:
providing a remote device access, via a network, to a social network platform, wherein the social network platform is associated with a type of activity, and wherein the social network;
receiving, via activation of a selectable user interface element included in a user's feed, a request to view game sessions;
in response to receiving the request, generating a list of available gaming sessions, wherein the list of available gaming sessions comprises one or more activable elements associated with one or more gaming sessions in the list of available gaming sessions;
receiving an indication of selection of an activatable element in the list of available gaming sessions;
when the activatable element is associated with joining a gaming session:
retrieving, from a gaming session datastore, information related to the gaming session; and
providing the information related to the gaming session; and
facilitating communication, via the social network platform, between two or more players associated with the gaming session.

20. The non-transitory computer storage medium of claim 19, wherein the method further comprises:
receiving a list of invitees to a league, the list of invitees comprising a plurality of players;
sending invites to each of the plurality of players, wherein an invite includes an activatable user interface element which, upon activation, generates a response to the invite;
in response to sending the invites, receiving a plurality of join responses, wherein users associated with the plurality of join responses are added to a league dataset.
upon expiration of a predetermined time, generating a roster of players based upon the plurality of users added to the league dataset; and
randomly generating two or more groupings of the plurality of users added to the league dataset; and
for each or the two or more groupings, automatically generating a schedule of gaming sessions.
